(19) United States
(12) Patent Application Publication
(10) Pub. No.: US 2025/0369373 A1
(43) Pub. Date: Dec. 4, 2025

(54) VALVED-PISTON AND ACTUATOR WITH RECYCLED COMBUSTION

(71) Applicant: Roger A. Benham, San Diego, CA (US)

(72) Inventor: Roger A. Benham, San Diego, CA (US)

(21) Appl. No.: 19/300,927

(22) Filed: Aug. 15, 2025

Related U.S. Application Data
(63) Continuation-in-part of application No. PCT/US24/16400, filed on Feb. 19, 2024.
(60) Provisional application No. 63/485,759, filed on Feb. 17, 2023.

(51) Int. Cl. F01L 1/02; F01L 11/02; F02B 43/02; F02B 43/12; F02M 61/14; F16H 7/02

(52) U.S. Cl. CPC F01L 1/024; F01L 11/02; F02B 43/02; F02B 43/12; F02M 61/14; F16H 7/02

(57) ABSTRACT

A reciprocating piston with exhaust valve suitable for power generation are disclosed. In particular, a reciprocating engine especially suited for the combustion of pressurized hydrogen gas with specific advantages that make it better suited for very large displacement engines is disclosed.

### CROSS REFERENCE TO RELATE APPLICATIONS

This application is a continuation in part of PCT Application No. PCT/US24/16400, entitled “VALVED-PISTON AND ACTUATOR WITH RECYCLED COMBUSTION,” filed Feb. 19, 2024, which claims the benefit of U.S. Provisional Application Ser. No. 63/485,759, entitled “VALVED-PISTON AND ACTUATOR,” filed Feb. 17, 2023, which is incorporated herein by reference.

### BACKGROUND OF THE INVENTION

### 1. Field of the Invention

The present invention relates to an improved method of power generation, and in particular a reciprocating internal combustion engine especially suited for the combustion of a pressurized fuel, including hydrogen gas, and a pressurized oxidizer, including oxygen gas, and a valved-piston with combustion gas recirculation, that is especially suited for large displacement engines.

### 2. Discussion of Related Art

Broadly speaking, in the present day, there are three distinct types of combustion engines that satisfy a majority of the power generation needs of the world's population. These include the purely rotational mechanism of the turbine engine, and the two reciprocating mechanisms of the diesel engine and the four-stroke internal combustion engine. There are several other combustion engines that exist, such as the two-stroke engine and the Wankel rotary engine. However, these designs have never risen to the ranks of usage like the other three, primarily due to difficulties related to sealing and lubrication.

In the present day, there is considerable discussion about electrification of vehicles used for on and offroad applications, to replace aging fossil-fired vehicles, such as automobiles, shipping trucks, buses, and seagoing ships. Advances in electrochemical storage using batteries are touted as justification for someday making all our vehicles powered by electric motors. Also, fuel cells that convert hydrogen gas directly into electricity are being pursued as an alternative to fossil-fired combustion engines.

Toyota Motor Company, is probably the world's largest manufacturer of motor vehicles, and has developed a reputation for quality, well-designed vehicles. Toyota has pioneered the application of battery-combustion hybrid technology, with electric drivetrains that eliminate conventional transmissions, even to the extent that their Prius model was a statement car for ecologically-minded advocates of the green revolution. Currently, most automobile manufactures have produced and offered to the public either hybrid or purely electric drivetrain vehicles. Toyota and Honda have both offered to the public electric powered vehicles with electricity provided by a fuel cell powered by pure hydrogen, called the Mirai and Clarity, respectively.

Interestingly however, Toyota and Honda have been criticized for not giving their full attention to electric drivetrains and moving forward with a larger offering of pure battery powered electric vehicles. Why would Toyota and Honda, with all their expertise, design and manufacturing capability, and loyal customer base, not rapidly move forward with the conversion to battery powered vehicles? There are news articles circulating that these companies are poised to drag the whole economy of Japan down the drain because they do not want to “change their ways.” Opinions have been circulated that some car companies are in bed with the petroleum industry and do not want to face the expense of retooling. Or, could the reluctance of these manufacturers to convert their whole product line to non-combustion vehicles be related to something factual, based on their deep knowledge and understanding of the limits of battery powered or fuel-cell powered vehicles?

It is known that the costs associated with the availability of raw materials and the pollution consequences of production and disposal of batteries could hinder the suitability of battery powered vehicles to satisfy the world-wide needs. Fuel-cells that convert hydrogen directly to electricity also rely on precious metals, which would hinder them from becoming mainstream. Hydrogen powered fuel-cells are also susceptible to contamination that deteriorate the performance of the devices, and therefore rely on intricate gas filters, hardly the type of device that could be produced on a mass scale to a public that demands reliable products from manufacturers.

Going back to Toyota, it is interesting that the company recently announced that they are focusing efforts on the combustion of hydrogen, and steering away from hydrogen fuel-cells that produce electrical power. There are also other large manufacturers, such as Mercedes-Benz and Cummins, that have touted the combustion of hydrogen in reciprocating type four-stroke engines as a leading candidate for zero emission vehicles, especially those with large displacement engines that power trucks and heavy offroad vehicle applications.

An important thread in the discussion of converting our energy needs away from fossil fuels is the subject of energy storage. With the use of renewable energy sources such as wind and solar there is a great need to store electrical power that is generated during peak generating periods, such as when the wind blows or the sun shines, for use when wind does not blow or the sun does not shine. In fact, the problem of energy storage is seen as paramount to the ability to convert from fossil fuels to renewable energy.

The ability to produce and store hydrogen gas under pressure, by electrolysis with electrical current generated from wind and solar, is touted as a leading option for the energy storage to convert our world from the dependence of fossil fuels. In addition to energy storage to power our cities, this ability to store energy in the form of hydrogen has led large companies, such as Boeing and Airbus, to dedicate large sums of money and talent to the development of hydrogen powered aircraft.

There are various methods presently available for the production of rotational energy. These various designs all have their benefits and shortcomings. The valved-piston assembly described in this patent application is well suited to convert a combustible fuel, such as hydrogen gas, to rotational energy to conduct work, whether directly for moving vehicles or equipment or the generation of electricity. The present valved-piston assembly is designed to provide additional options for power generation compared to other presently available alternatives, and is particularly important for the improvement in quality and cost benefits to the consumer.

### BRIEF SUMMARY OF THE DISCLOSURE

The present invention is directed to an improved power generation engine that uses a valved piston in a reciprocating engine device which at least partially overcomes the disadvantages of existing systems. The present valved-piston assembly also provides the consumer with a useful or commercial choice regarding power generation engines.

An improved reciprocating piston with an exhaust valve suitable for power generation is disclosed; in particular, a reciprocating engine especially suited for the combustion of pressurized hydrogen gas with specific advantages that make it better suited for very large displacement engines. Advantages include lightweight and easily manufactured crankshaft (simple tube or shaft), no cylinder head (works on pulling principle), light weight non-structural cylinder walls (no head bolts or associated loads), direct injection of both fuel and oxidizer, direct injection of oxidizer (oxygen) for practical elimination of nitrous oxide emissions, variable compression due to use of pressurized fuel and oxidizer source, and variable combustion gas recycling, full pressure lubrication and cooling, condensing cycle on gas output side of piston, combustion product capture and reuse (water recovery for reuse in electrolyzer, carbon dioxide capture), variable stroke capability, variable valve timing capability, inherent free spin capability, inherent on-off capability for each individual piston (simple electronic shut-down of fuel injector allows engine to run as 2-stroke, 4-stroke, 8-stroke, 16, stroke, or any desirable on-off firing pattern, with no mechanical alterations required of basic crankshaft mechanism), and, simple and compact construction compared to alternative or traditional crankshaft engines.

In a broad form, the invention resides in a valved-piston assembly that is actuated by two crankshaft journals, or journal-less camcrank assemblies. In accordance with a disclosed embodiment, the journal-less camcrank assembly is as described in detail in Applicant's prior patent application, see U.S. Patent Application Publication No. 2014/0224116, which is incorporated herein by reference.

In one disclosed embodiment, one of the journal-less camcrank assemblies (the power-camcrank assembly) is attached to the exhaust-valve assembly of the valved-piston assembly, and the other camcrank assembly (the exhaust-camcrank assembly) is attached to the piston-body part of the valved-piston assembly. It is appreciated that it would seem more logical to say the exhaust-camcrank assembly is connected to the exhaust valve part of the valved-piston assembly, but in the example provided herein, it is through force on the piston body by the exhaust camcrank assembly that the exhaust-valve opening between the exhaust-valve assembly and the main piston body is opened, and will be shown in further description of the valved-piston assembly. This could be used in the inverse manner as well, where the exhaust-camcrank assembly is connected to the exhaust valve part of the valved-piston assembly, see FIG. 7. However, for the purpose of explaining the valved-piston assembly, we will use the former arrangement for the initial explanation of the valved-piston assembly.

For the purposes of conveying the concepts on how the present valved-piston assembly works, consider that the exhaust-camcrank assembly produces a shorter stroke than the power-camcrank assembly. For example, one can say the exhaust-camcrank assembly produces a stroke of 100 mm, and the power-camcrank assembly produces a stroke of 150 mm. Also, let us consider that the exhaust-camcrank assembly is fixedly set to rotate 15-degrees in advance of the power-camcrank assembly. And, in this configuration, the power-camcrank assembly is connected to the exhaust-valve assembly of the piston-valve assembly by a flexible power-band, and the exhaust-camcrank assembly is connected to the piston-body portion of the piston-valve assembly by a flexible exhaust band.

It can be seen that as the piston assembly is acted upon by pressurized gas (combustion gas), at some position before bottom-dead center of the valved-piston assembly, the force on the valved-piston assembly is transferred to the power-camcrank assembly via the flexible power-band, causing the power-camcrank assembly to rotate (produce power and work to the output shaft). Observation of the graphical representation of this mechanism shows that there is slack in the flexible exhaust-band that connects the exhaust-camcrank assembly to the main piston body portion of the piston-valve assembly.

Because of the shorter stroke of the exhaust-camcrank assembly (100 mm), when the exhaust-camcrank assembly reaches 180-degrees in rotation, or top-dead-center of the exhaust-camcrank stroke, it stops the piston-body from moving, while at the same time, the exhaust-valve assembly of the piston-valve assembly is free to keep moving along the larger stroke of the power-camcrank assembly (150 mm). At this point, tension is seamlessly transferred from the flexible power-band to the flexible exhaust-band, and the exhaust-valve opening opens as the piston-valve assembly moves relative to the main piston body.

As observation of the graphical representation in the drawings shows, during the first part of the returning downward stoke, the exhaust-valve opening remains open due to the tension on the piston body portion of the valved-piston assembly via the flexible exhaust-band connected to the exhaust-camcrank assembly (which is 15-degrees in advance of the power-camcrank assembly), therefor exhausting the combustion gases during this portion of the downward stroke. When the exhaust-camcrank assembly approaches the bottom-dead-center (of the 100 mm stroke), at this approximate location, the power-camcrank which is pulling the exhaust-valve assembly of the valved-piston assembly at a faster velocity (due to its longer stroke of 150 mm), “catches up” with the piston-body portion of the valved-piston assembly, thereby closing the exhaust-valve.

This phenomenon, where the higher velocity of the power-camcrank assembly relative to the exhaust-camcrank assembly, causes the exhaust-valve assembly of the valved-piston assembly to “catch up” to the piston-body portion of the valved-piston assembly, thereby closing the exhaust valve opening, and the associated seamless transfer of tension between the two actuating bands, and the transfer of tension on the before-mention power stroke, are key revelations and discoveries associated with this valved-piston assembly.

After this point in the downward stroke (at some desired point before bottom-dead-center of the exhaust-camcrank stroke of 100 mm), there is the additional downward stroke movement caused by the tension in the flexible power-band caused by the remaining rotation of the power-camcrank assembly (150 mm stroke). This additional downward movement caused by the tension in the flexible power-band is where fuel and oxidizer are injected for compression and combustion in the ensuing next power stroke, which commences with the spark ignition at approximately bottom-dead-center of the power-camcrank stroke. It is this adjustable and variable “timing” of the closure of the exhaust valve opening, at some desired point before bottom-dead-center of the exhaust-camcrank stroke, which enables a variable compression ratio. This variable compression ratio enables the use of a larger diameter piston with a large stroke, where larger piston-diameter to piston-stroke ratios could not be achieved in a conventional valved-head internal combustion engine due to compressibility limits or efficiency losses. Because the flexible bands used in this described embodiment do not provide a stopping force for the piston-assembly moving in the downward direction as it approaches bottom-dead-center, in addition to the forces created by the compression of the fuel and oxidizer, accommodations are made to mitigate potential damage caused by impact forces of the valved-piston assembly contacting the cylinder plate.

It is noted that fuel and oxidizer are injected from pressurized sources. It is common for fuel to be injected under extremely high pressure by either mechanically, electronically, or electro-mechanically actuated fuel injectors. In the prior patent application referenced by the Applicant, U.S. Patent Application Publication No. 2014/0224116, the compression cycle associated with the oxidizer (air) is conducted in a separate device (separate compressor) and the oxidizer is injected under pressure. This feature of the combustion cycle described above lends itself well to the combustion of hydrogen gas, since hydrogen gas is always delivered under compression.

Also, as stated herein, the oxidizer is injected under pressure, including the use of nearly pure oxygen gas, which is always delivered in the form of a compressed gas. As described herein, the injection of nearly pure oxygen accompanied by the recycling of combustion products during subsequent compression stage is referred to as a “Recycled Combustion Engine.”

Also described herein regarding the Valved-Piston and Actuator with Recycled Combustion, are the discoveries related to the valved-piston assembly mechanisms, full pressure lubrication of the moving valved-piston assembly, and inherent cooling by the full pressure lubrication.

In an aspect an internal combustion drive system includes at least one crankshaft assembly and at least one valved-piston assembly that includes an exhaust-valve and a main piston-body positioned within a cylinder. The at least one crankshaft assembly is connected to the at least one valved-piston assembly via a flexible power-band to transmit power to the at least one crankshaft assembly.

In some embodiments a stop mechanism is included at a top of the cylinder to make impact with the exhaust-valve assembly of the valved-piston assembly, causing the exhaust valve to momentarily open and release combustion gases.

In another aspect an internal combustion drive system includes at least one first crankshaft assembly, at least one second crankshaft assembly, and at least one valved-piston assembly that includes an exhaust-valve assembly and a piston-body positioned within a cylinder. The at least one first crankshaft assembly is connected to the valved-piston assembly via a flexible power-band to transmit power to the at least one first crankshaft assembly, and the at least one second crankshaft assembly being connected to the valved-piston assembly via a flexible exhaust-band to actuate to move the exhaust-valve assembly relative to the main piston-body to open and close the at least one valved-piston assembly.

In some embodiments the at least one first crankshaft assembly is connected via the flexible power-band to the piston-body and the second crankshaft assembly is connected via the flexible exhaust-band to the exhaust-valve assembly.

In some embodiments the at least one first crankshaft assembly is connected via the flexible power-band to the exhaust-valve assembly and the at least one second crankshaft assembly is connected via the flexible exhaust-band to the piston-body.

In some embodiments the cylinder includes a cylinder-plate assembly on one end of the cylinder and an atmospheric opening port on another end of the cylinder.

In some embodiments the cylinder-plate assembly includes a fuel-intake-port, an oxidizer-intake-port, and a sparkplug.

In some embodiments the pressurized fuel and pressurized oxidizer are injected into the fuel-intake-port and oxidizer-intake-port with mechanical, electrical, and/or electro-mechanical injectors.

In some embodiments the fuel-intake-port and oxidizer-intake-port are mounted on a side of the cylinder-plate assembly to cause a tangential flow and circular pattern of an oxidizer.

In some embodiments the cylinder-plate assembly includes a stanchion with a hollow core to enable passage of at least one flexible power-band and at least one flexible exhaust-band connection to the at least one second crankshaft assembly.

In some embodiments the exhaust-valve assembly has the hollow core to closely match a diameter of the stanchion to enable the valved-piston assembly to reciprocate on the stanchion.

In some embodiments the hollow core of the exhaust-valve assembly has a dynamic seal for engagement with an outer diameter of the stanchion.

In some embodiments the stanchion includes a port for release of lubricating and cooling fluid.

In some embodiments a first power-band idler assembly which guides the flexible power-band of the at least one first crankshaft assembly and provides a fixed and non-restrictive pivot point for motion of the flexible power-band of the at least one first crankshaft assembly.

In some embodiments a second exhaust-band idler assembly which guides the flexible exhaust-band of the at least one second crankshaft assembly and provides a fixed and non-restrictive pivot point for motion of the flexible exhaust-band the at least one second crankshaft assembly.

In some embodiments the second crankshaft assembly is in an advanced or retarded angle compared to the first crankshaft assembly.

In some embodiments the second crankshaft assembly is a different diameter compared to the first crankshaft assembly to affect open and close timing of the exhaust-valve assembly relative to the main piston-body.

In some embodiments shortening or lengthening of the flexible exhaust-band affects timing of the opening and closing of the of the exhaust-valve assembly relative to the main piston-body.

In some embodiments a variable lift rotating cam is used to change the length of the flexible exhaust-band, affecting timing of the opening and closing of the of the exhaust-valve assembly relative to the main piston-body, thereby changing an amount of compression during a compression cycle.

In some embodiments shortening or lengthening of the flexible power-band affects a stoke length of the valved-piston assembly, thereby changing a compression ratio of a compression cycle.

In some embodiments a variable lift rotating cam changes the length of the flexible power-band.

In some embodiments an electro-mechanical mechanism changes a length of the flexible power-band.

In some embodiments an electro-mechanical mechanism is used to change the length of the flexible exhaust-band, affecting timing of the opening and closing of the of the exhaust-valve assembly relative to the main piston-body, thereby changing an amount of compression during a compression cycle.

In some embodiments the main piston body includes a piston body bottom plate, a piston body exhaust valve seat, a piston body upper plate, a piston body flanged member, a piston body extension tube, and at least one dynamic seal.

In some embodiments the exhaust-valve assembly includes an exhaust valve plate, an exhaust valve seat, a flanged member, and at least one seal.

In some embodiments the exhaust-valve assembly also includes an inner extension tube and an outer extension tube that create an exhaust valve annulus that provides a path for pressurized lubrication and cooling.

In some embodiments the exhaust valve plate and the exhaust valve seat of the exhaust-valve assembly move relative to the piston body bottom plate and the piston body exhaust valve seat of the piston body to create a passageway for exhaust gas.

In some embodiments the valved-piston assembly includes a pressurized lubrication outer jacket in which pressurized lubrication fluid is contained by seals at a top and bottom of the valved-piston assembly.

In some embodiments the cylinder has at least one port to provide lubrication and/or cooling fluid into the outer jacket, where the port coincides with the seals at the top and bottom of the valved-piston assembly to contain full pressure lubrication and flow during reciprocating motion of the valved-piston assembly.

In some embodiments the valved-piston assembly also includes a full pressure lubrication inlet port and a lubrication outlet port that releases to at near atmospheric pressure where the lubrication and cooling fluid drains down.

In some embodiments the main piston body includes piston body exhaust ports.

In some embodiments a bias force holds the exhaust-valve assembly and the main piston body in an open or closed position.

In some embodiments the bias force is created by fluid pressure.

In some embodiments the bias force is created by a spring mechanism.

In a further aspect a method of using a valved-piston assembly is disclosed. The valved-piston assembly comprises a first crankshaft assembly functioning as a “power-crankshaft assembly,” a second crankshaft assembly functioning as an “exhaust-crankshaft assembly,” wherein the valved-piston assembly includes an exhaust-valve assembly and a main piston body positioned within a cylinder. The valved-piston is connected to the first crankshaft assembly via a first flexible power-band to transmit power to an output shaft, and a second crankshaft assembly via a flexible exhaust-band to actuate the exhaust valve on and off. The method comprises: a) beginning with the first crankshaft assembly and the valved-piston assembly at 0-degrees rotation, with exhaust-valve assembly of valved-piston closed, a combustion chamber charged with fuel and oxidizer, igniting fuel and oxidizer causing expanding combustion gas; (b) expanding combustion gas exerts force on valved-piston rotating the first crankshaft assembly causing work to be done at a drive shaft, with additional force maintaining closure of exhaust-valve assembly of valved-piston due to closing force caused by combustion gas pressure on a frontal piston-body surface area portion of the valved-piston assembly, wherein continued expansion of combustion gases causing tension in the first flexible power-band connected to the first crankshaft assembly, wherein due to slack in the flexible exhaust-band during this period of rotation no force is transmitted between the valved-piston assembly and the second crankshaft; (c) due to the shorter stroke length of the flexible exhaust-band connected to the second crankshaft, at a rotation angle just before 180-degrees further rotating the first crankshaft assembly causes the flexible exhaust-band to reach its top-dead-center of its shorter stroke length causing its upward motion to stop, causing full tension in the flexible exhaust-band, which causes the exhaust-valve assembly of the valved-piston assembly to open, releasing combustion gas out an end of the cylinder, where coinciding with transfer of tension from the first flexible power-band to the flexible exhaust-band of the second crankshaft assembly, causes downward motion of the exhaust-valve assembly of the valved-piston assembly (with valve open); (d) further rotating the first crankshaft assembly causes the main piston-body to reach its top-dead-center at its 180-degree rotation, stop, and begin to accelerate down, and due to a longer stroke length of the first crankshaft assembly (compared to the second crankshaft assembly), the main piston-body accelerates downward at a higher rate of motion than the motion of the exhaust-valve assembly of the valved-piston assembly; (e) at a predetermined position in a downward stroke, 250-degrees for example due to the higher acceleration of the main piston body, the main piston-body of the valved-piston assembly “catches up” with the exhaust-valve assembly of the valved-piston assembly, producing slack in the flexible exhaust-band which causes the exhaust-valve to seal against the main piston body, closing the valve and make a positive seal; (f) the degree of rotation when the main piston-body of the valved-piston assembly “catches up” with the exhaust-valve assembly of the valved-piston assembly, coincides with transfer of tension from the flexible exhaust-band to the flexible power-band, and commences a compression stage of a cycle, where the combustion gases remaining in a combustion chamber area below the valved-piston assembly before the exhaust-valve closed are compressed by continuing rotation of the first crankshaft assembly and transfer of tension through the flexible power-band; (g) fuel and oxidizer are injected some time between the 250-degrees and 360-degree of rotation; and (h) returning to the position of 0-degress for a next power stroke.

In some embodiments fuel is hydrogen and the oxidizer is nearly pure oxygen.

In some embodiments fuel is hydrocarbon and oxidizer is air.

In some embodiments step (e) further includes injection of oxidizer to purge remaining combustion gases.

In another aspect an internal combustion drive system is provided in which a stoichiometric ratio of pressurized fuel and oxidizer is injected into a sealed combustion chamber, without inclusion of air, for ignition, combustion, subsequent expansion to do work, and exhaust.

In some embodiments the fuel is nearly pure hydrogen and the oxidizer is nearly pure oxygen, to produce a combustion gas of nearly pure water.

In some embodiments the pressure on an exhaust side is controlled with a pressure regulator mechanism to optimize condensation of combustion gas.

In some embodiments the combustion gases of water vapor are routed to a heat exchanger or condenser and cooled to assist causation of condensation of combustion gases to liquid.

In some embodiments combustion gas condensate is contained for reuse, including used as heat transfer media for heat exchangers or condensers or sent to electrolyzer for conversion to hydrogen and oxygen.

In some embodiments the fuel is hydrocarbon and the oxidizer is nearly pure oxygen, to produce a combustion gas of nearly pure water and nearly pure oxides of carbon.

In some embodiments the pressure on an exhaust side is controlled with a pressure regulator mechanism to optimize condensation of the combustion gas, including condensation of water component and carbon dioxide component of the combustion gases.

In some embodiments the combustion gases are routed to a heat exchanger or condenser and cooled to cause condensation of a water vapor component of the combustion gases to liquid, and the remaining combustion gases continue to next processing step.

In some embodiments the combustion gas condensate is contained for reuse, including used as heat transfer media for heat exchangers or condensers or sent to electrolyzer for conversion to hydrogen and oxygen.

In some embodiments the remaining combustion gases are routed to a compressor for compression to a pressure to cause condensation of the combustion gases condense to liquid phase.

In some embodiments the compressed remaining combustion gas are routed to a heat exchanger or condenser and cooled to assist condensation process of the remaining component of combustion gas to compressed liquid phase.

In some embodiments the compressed liquid phase of the remaining combustion gas is contained for carbon capture or reuse, including used as feedstock for reformation to carbon neutral fuel.

In a further aspect an internal combustion drive system includes at least one first crankshaft assembly, at least one second crankshaft assembly, and at least one valved-piston assembly that includes an exhaust-valve assembly and a piston-body positioned within a cylinder. The at least one first crankshaft assembly is connected to the valved-piston assembly via a flexible power-band to transmit power to the at least one first crankshaft assembly, and the at least one second crankshaft assembly being connected to the at least one valved-piston assembly via a flexible exhaust-band to actuate to move the exhaust-valve assembly relative to the main piston-body to open and close the at least one valved-piston assembly, wherein changing a length of the flexible power-band changes an amount of compression done during a compression cycle, or compression portion of a 360-degree rotation, by adjusting how far down the valved-piston assembly will travel.

In some embodiments shortening the length of the flexible power-band, in real-time during operation, allows an infinitely variable compression ratio.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIGS. 1A through 1F are a series of drawings describing the sequence of events occurring with the activation of a valved-piston assembly relative to the 360-degree rotation of two camcrank assemblies connected to the valved-piston assembly. The first camcrank assembly is the “power-camcrank assembly,” and the second camcrank assembly is the “exhaust-camcrank assembly” which is 15-degrees in advance rotational angle relative to the first camcrank assembly. It should be noted that the drawings shown in FIGS. 1A through 1F are for describing the operation of the invention of the valved-piston, including how forces are transmitted and how the exhaust valve opens and closes during the 360 degree rotation of the crankshaft, and are not literal descriptions or representations of how the valved-piston assembly 1 and actuation mechanisms would be manufactured. For example, no consideration is being made in FIGS. 1A through 1F, or the descriptions thereof, of the ability to make reliable seals between components for containment of pressured gas or fluid, or abilities of materials to perform under the loading and wearing surfaces shown in FIGS. 1A through 1F. The operation of the valved-piston assembly does not rely on the shorter stroke or the 15-degree advancement of the exhaust-camcrank assembly because the valve opening could be accomplished with the application of a variable timing cam, see FIG. 1G. Again, the illustrations of FIGS. 1A through 1F are for communicating the operation of the valved-piston and actuation functions. Also, in the following description, and throughout this application, the terms crankshaft, journal less crankshaft, and camcrank, can be used interchangeably when describing different functions, and generally refers to a rotating mechanism that causes a piston to move in one way or another.

FIG. 1A shows a power-camcrank assembly connected to a centrally located exhaust-valve of the valved-piston assembly, and an exhaust-camcrank assembly connected to the main piston-body of the same valved-piston assembly. FIG. 1A shows the power-camcrank assembly and valved-piston assembly at 0-degrees rotation (bottom-dead-center (that is, the point at which the piston of an engine is nearest to the axis of the crankshaft that may be referred to as “BDC” herein)) of the 360-degree rotation. In accordance with the present valved-piston assembly, bottom-dead-center of the power-camcrank assembly is the beginning of the power stroke.

FIG. 1B shows the power-camcrank assembly at 90-degrees clockwise rotation from bottom-dead-center. The piston assembly is approximately half-way through the power stroke, with the exhaust-valve closed due to closing force caused by combustion pressure on the piston-body portion of the valved-piston assembly causing tension in the flexible power-band connected to the power-camcrank assembly.

FIG. 1C shows the power-camcrank assembly at 15-degrees before top-dead-center (that is, the position of a piston in which its head is the farthest away from the crankshaft that may be referred to as “TDC” herein). At this position, the exhaust-camcrank assembly has reached top-dead-center, and full tension has been transferred from the flexible power-band to the flexible exhaust-band, causing the main piston-body to stop further travel in the direction of the power stroke. At approximately this point in the travel of the valved-piston assembly, there is a transfer of tension from the flexible power-band to the exhaust band and slack is beginning to occur in the flexible power-band, and the exhaust-valve is free to open.

FIG. 1D shows the power-camcrank assembly at 180-degrees, top-dead-center of the power-camcrank assembly rotation. At this position, the exhaust-camcrank assembly is 15-degrees in advance of the power-camcrank assembly, and full tension is in the flexible exhaust-band, pulling on the piston-body and fully opening the exhaust-valve, and pulling the entire valved-piston assembly down, exhausting combustion gases from the cylinder. Because the power-camcrank assembly rotation is behind the rotation of the exhaust-camcrank assembly, there is slack in the power-band.

FIG. 1E shows the exhaust-camcrank assembly at approximately 315-degrees. At approximately this position, due to the increased speed of the power-camcrank assembly (due to its longer stroke), the exhaust-valve has “caught up” to the exhaust-valve assembly of the valved-piston assembly, seamlessly transferring tension from the flexible exhaust-band to the flexible power-band, which causes the exhaust-valve to close against the piston-body and make a positive seal. At this point, the majority of the combusted gases have been exhausted. At this point, and during the remaining distance of the downward stroke, oxidizer and fuel can be injected and compressed for the next power stroke. Because the flexible power-band is advancing the movement of the valved-piston assembly, by the advancing power-camcrank assembly, there is slack in the flexible exhaust-band.

FIG. 1F shows the exhaust-camcrank assembly at 360-degrees (or 0-degrees). At this position, the power-camcrank assembly is 15-degrees behind in rotation, and full tension is in the flexible power-band. Oxidizer and fuel have been injected, and with a spark from the sparkplug, the next power stroke, as shown in FIG. 1A is ready to commence, at or around bottom-dead-center of the stroke of the power-camcrank assembly. Because the flexible power-band is in contact and advancing the movement of the valved-piston assembly, there is slack in the exhaust band.

FIG. 1G shows an alternative method of actuating the exhaust valve opening, valve open-and-closure timing, and enabling variable compression ratio for the ensuing combustion, by means of a rotating cam timing system with variable valve timing cam and/or a variable band length adjustment mechanism.

FIG. 1H shows a conventional crankshaft for the power stroke and a separate flexible membrane to actuate the exhaust valve opening with valve open-and-closure timing.

FIG. 2 shows a top view of the schematics shown in FIGS. 1A through 1F.

FIG. 2A shows the structure of FIG. 2 with the placement of electronic fuel injectors shown in accordance with a disclosed embodiment.

FIG. 3 provides a sectional view through a detailed embodiment of the valved-piston assembly, in the closed exhaust valve position, with movement constraints, pressurized valve closure bias, seal locations, and exhaust gas passage.

FIGS. 3A, 3B, and 3C provide detailed sectional views through elements of the valved-piston assembly.

FIG. 4 shows a sectional view through the embodiment of the valved-piston assembly shown in FIG. 3, with the exhaust-valve in the fully open position, with movement constraints, pressurized valve closure bias, seal locations, and exhaust gas passage.

FIG. 5 shows a sectional view through an embodiment of the valved-piston assembly in the near top-dead-center position, with the exhaust-valve in the open position, showing the full pressure lubrication of the moving components, and the cooling circuit offered by the full pressure lubrication. In the near top-dead-center position the lubrication fluid is shown venting out of the valved-piston assembly through the port located at the top of the stanchion, into the central bore of the stanchion, and back into the crankcase of the engine.

FIG. 6 shows a top view of the valved-piston assembly showing the exhaust gas passages.

FIG. 7 shows an alternate embodiment where the exhaust-camcrank assembly is connected to the exhaust valve assembly of the valved-piston assembly, by means of a flexible exhaust-band, and the power-camcrank assembly is connected to the main piston-body, by means of the flexible power-band. This configuration is the opposite of the flexible band configuration shown in FIGS. 1A-G.

FIG. 8 shows the pressurized oil lubrication and cooling of the valved-piston assembly described in FIG. 7 in the near bottom-dead-center position, with the exhaust-valve in the closed position, during compression and subsequent ignition of the injected fuel and oxidizer. The lubrication port on the top end of the stanchion is “closed” causing an “off,” or stoppage, of oil flow and a full pressure oil lubrication condition with the valved-piston assembly. The no-flow and full oil pressure lubrication condition, in addition to the placement of seals at all potential gas escape points, prevents high pressure gas within the combustion chamber from escaping during the power and compression stroke.

FIG. 9 shows the process stream for the Recycled Combustion for combusting nearly pure hydrogen and oxygen, where the pressure of combustion (compression ratio) is infinitely variable, and the combustion product (water) is condensed and recycled to an electrolyzer or other use.

FIG. 10 shows the process stream for the Recycled Combustion for combusting a hydrocarbon fuel with nearly pure or concentrated oxygen, where the pressure of combustion (compression ratio) is infinitely variable. The combustion products, including water and carbon dioxide, are condensed, and recycled, for reuse and carbon sequestration, respectively.

FIG. 11 shows a top view of the general cylinder and camcrank and cylinder location of a multi-cylinder embodiment of the invention.

### DETAILED DESCRIPTION

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

The description of the valved-piston assembly 1 and actuator at least partially relies on reference to the journal-less camcrank assembly described in detail in Applicant's prior patent application, see U.S. Patent Application Publication No. 2014/0224116, which is incorporated herein by reference. In this prior patent application, a camcrank assembly is engaged by a flexible membrane that transmits power to the camcrank mechanism by a pulling tension. It is further described that the connecting membrane is not fixedly attached to the camcrank assembly, but rather the connecting membrane only engages the camcrank assembly if there is pulling tension in the flexible membrane that causes the camcrank to move.

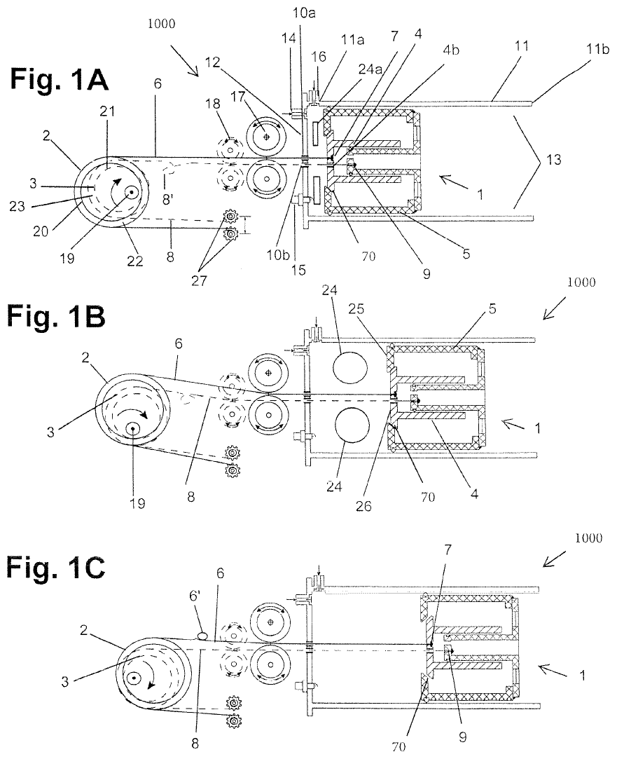

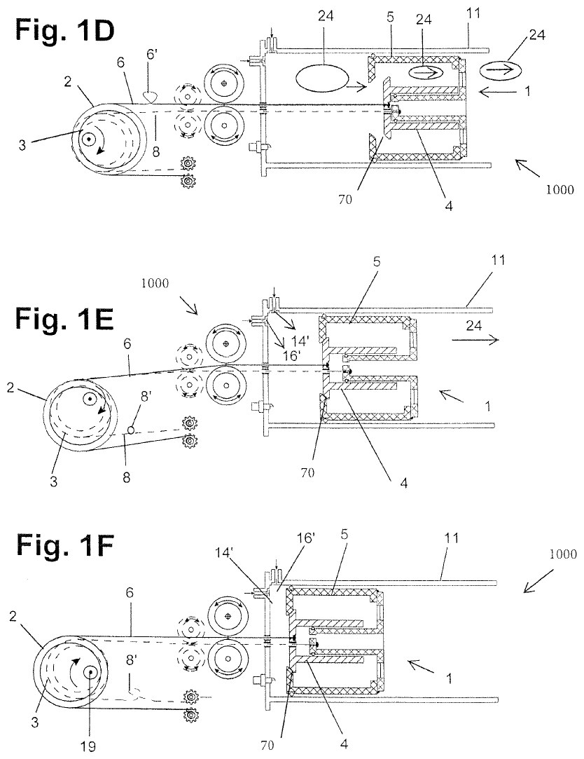

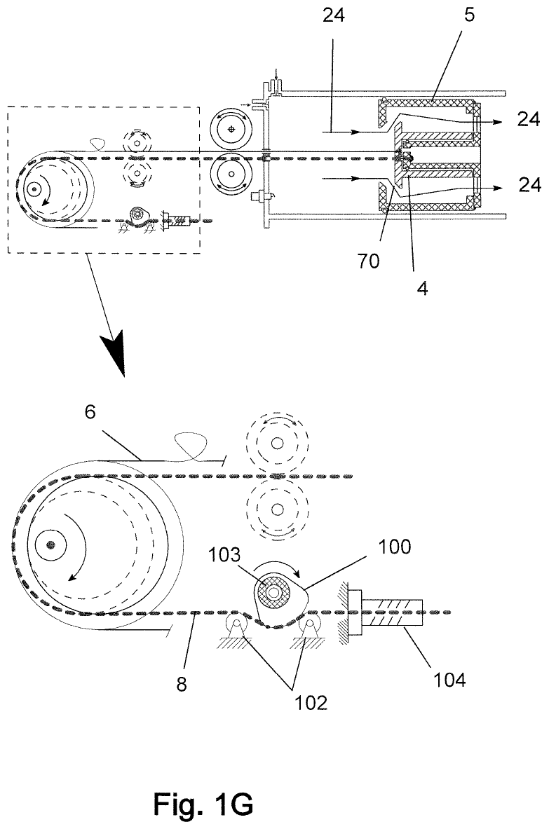

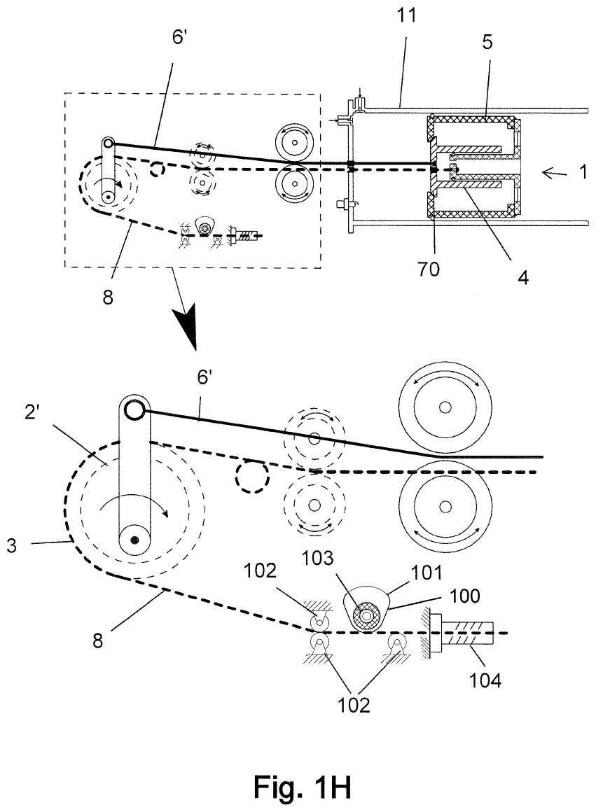

Referring to the various figures, an internal combustion drive system 1000 including valved-piston assembly 1 for use in conjunction with an internal combustion engine is disclosed. The present internal combustion drive system 1000 generally comprises a first camcrank assembly 2 functioning as a “power-camcrank assembly” and a second camcrank assembly 3 functioning as a “exhaust-camcrank assembly.” A valved-piston assembly 1 is connected to the first camcrank assembly 2 via a first flexible power-band 6 and connected to the second camcrank assembly 3 via a second flexible exhaust-band 8 such that actuation of the valved-piston assembly 1 drives the first camcrank assembly 2 to drive the drive shaft 19 that ultimately drivers a mechanical system requiring rotational power, and the second camcrank assembly 3 causes the opening of the exhaust-valve assembly 4 located within the valved-piston assembly. While the disclosed embodiment includes a valved-piston assembly connected to and driving camcrank assemblies, it is appreciated that the valved-piston assembly of the present invention could be used with a normal crankshaft. For example, a flexible band, connected to a normal crankshaft, is described in Applicant's own US Patent Application Publication No. 2014/0224116, which is incorporated herein by reference, and particular reference is made to FIGS. 1A and 1B thereof that show a flexible band connected to a normal crankshaft. As such, Applicant's reference to camcrank assemblies herein should be construed to broadly include crankshafts as disclosed in US Patent Application Publication No. 2014/0224116.

While a single cylinder is disclosed herein for the purposes of explaining the present invention, it is appreciated that the internal combustion drive system 1000 would likely work with a plurality of cylinders 11 working in a synchronized manner to drive a plurality of first and second camcrank assemblies 2, 3 connected via a drive shaft 50 linked to the mechanical system being driven.

The valved-piston assembly 1 includes an exhaust-valve assembly 4 and a main piston body 5 positioned within the cylinder 11. The first flexible power-band 6 connects the first camcrank assembly 2 to the exhaust-valve assembly 4 and the second flexible power-band 8 connects the second camcrank assembly 3 to the main piston body 5. The exhaust-valve assembly 4 includes exhaust-valve assembly seal bushing 4b and the second flexible exhaust-band 8 slips through the exhaust-valve assembly seal bushing 4b to allow free movement of the second flexible exhaust-band 8 and a perfect seal via the exhaust-valve assembly seal bushing 4b.

The valved-piston assembly 1 according to the disclosed embodiment, and as discussed above, is positioned in the cylinder 11 with the cylinder-plate assembly 12 on one end 11a of the cylinder 11 and an atmospheric opening port 13 on the other end 11b of the cylinder 11. The cylinder 11 is preferably circular in cross section, however, the use of oval shaped cylinders is an option, and may be sized as needed in accordance with specific application for which it might be implemented. The example provided shows the cylinder-plate assembly 12 including the fuel-intake-port 14, the oxidizer-intake-port 16, and the sparkplug 15, however the use of tangentially mounted intake ports could be an option to provide swirling effect (i.e., circular patten) of the fuel 14′ and oxidizer 16′ increasing efficiency of combustion.

In the shown embodiment, the flexible power-band 6 is secured to the exhaust-valve assembly 4, and the flexible exhaust-band 8 is secured to the main piston body 5, both of which are positioned within the cylinder 11. In accordance with a disclosed embodiment, welds 60 are used in the fabrication of the valved-piston assembly 1 and the respective flexible power-band 6 and the flexible exhaust-band 8 are secured to a first end 5a of the main piston body 5 via flange members 61a, 61b formed at the first end 5a of the main piston body 5. The cylinder-plate assembly 12 is engaged to the valved-piston assembly 1 by means of a fixed exhaust guide stanchion (in particular, a centrally located stanchion) 28, or a dynamic stanchion (not shown in drawings). Various sealing options exist, shown as dynamic seals 62a, 62b, 62c, and 62d, to allow a free movement of the flexible power-band 6, and the flexible exhaust-band 8 and a perfect seal to transmit power to their respective stations in the power cycle. Further still, the cylinder 11 is provided with a full pressure lubrication inlet port 63, and cooling, and a full pressure lubrication outlet port 64. As will be appreciated based upon the following disclosure.

As will be appreciated based upon the following disclosure, the cylinder-plate assembly 12 includes a centrally located stanchion with a hollow core to enable passage of a flexible power-band 6 and the flexible exhaust-band 8. The exhaust-valve assembly 4 has the hollow core to closely match a diameter of the centrally located stanchion 28 to enable the valved-piston assembly 1 to reciprocate on the centrally located stanchion 28. The hollow core of the exhaust-valve assembly 4 has a dynamic seal for engagement with an outer diameter of the centrally located stanchion 28. In addition, the stanchion 28 includes a port 28p for release of lubricating and cooling fluid.

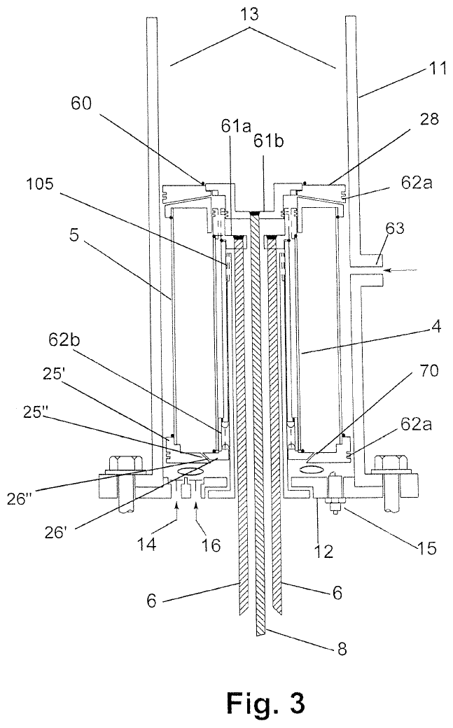

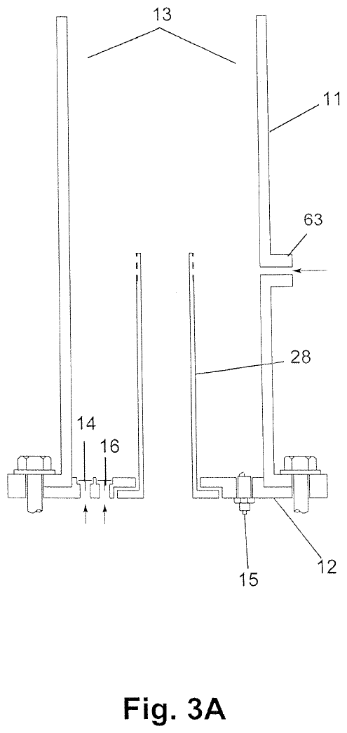

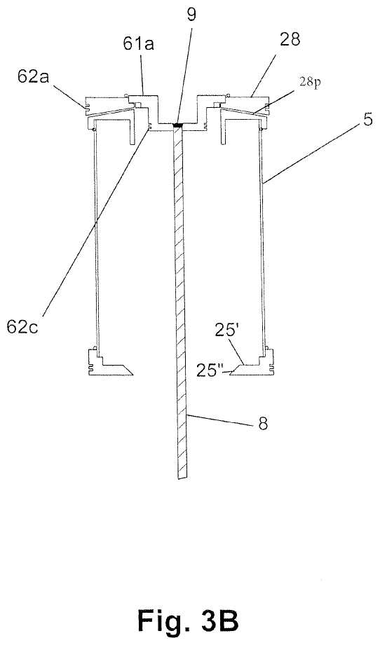

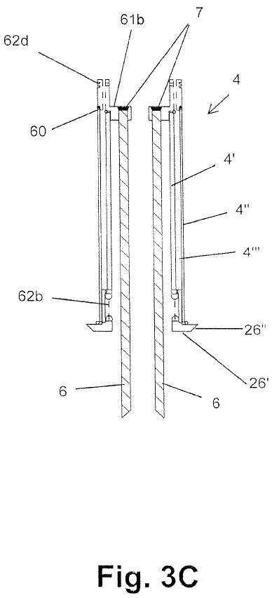

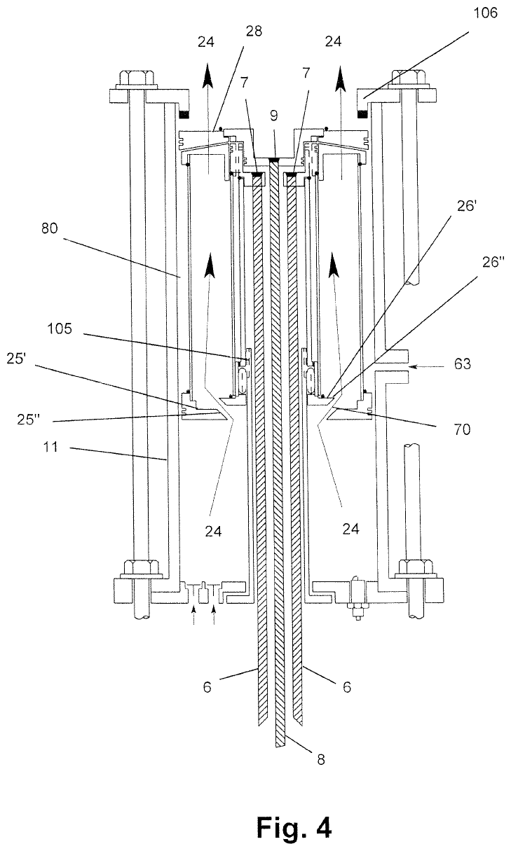

Referring to FIGS. 3, 3A, 3B, 3C, and 4, the main piston body 5 includes a piston body bottom plate 25′, a piston body exhaust valve seat 25″, a piston body upper plate (that is, stanchion) 28, a piston body flanged member 61a, a piston body extension tube 5′, and at least one dynamic seal 62a, 62c. The main piston body 5 includes piston body exhaust ports 66. The exhaust-valve assembly 4 includes an exhaust valve plate 26′, an exhaust valve seat 26″, a flanged member 61b, and at least one seal 62b, 62d. The exhaust-valve assembly 4 also includes an inner extension tube 4′ and an outer extension tube 4″ that create an exhaust valve annulus 4″′ that provides a path for pressurized lubrication and cooling. In practice, and as will be explained below in more detail, wherein the exhaust valve plate 26′ and the exhaust valve seat 26″ of the exhaust-valve assembly 4 move relative to the piston body bottom plate 25′ and the piston body exhaust valve seat 25″ of the main piston body 5 to create a passageway for exhaust gas, that is, the exhaust-valve opening 70 that moves between an open orientation and closed orientation and is defined by the exhaust-valve assembly 4 and the main piston body 5.

In addition, the assembly also includes a first power-band idler assembly 17 which guides the first flexible power-band 6 and provides a fixed and non-restrictive pivot point for motion of the first flexible power-band 6. A second exhaust-band idler assembly 18 which guides the second flexible exhaust-band 8 and provides a fixed and non-restrictive pivot point for motion of the second flexible exhaust-band 8.

The valved-piston assembly 1 also includes a full pressure lubrication (and cooling) inlet port 63 and a lubrication (and cooling) outlet port 64 that releases the lubrication and cooling fluid down into a fixed exhaust valve guide stanchion 28 at near atmospheric pressure where the lubrication and cooling fluid drains down. As such, the valved-piston assembly 1 includes a pressurized lubrication outer jacket 80 in which pressurized lubrication fluid is contained by seals at a top and bottom of the valved-piston assembly 1. The cylinder 11 has at least one port (that is, lubrication (and cooling) inlet port 63) to provide lubrication and/or cooling fluid into the outer jacket 80, where the port 63 coincides with the seals at the top and bottom of the valved-piston assembly 1 to contain full pressure lubrication and flow during reciprocating motion of the valved-piston assembly 1.

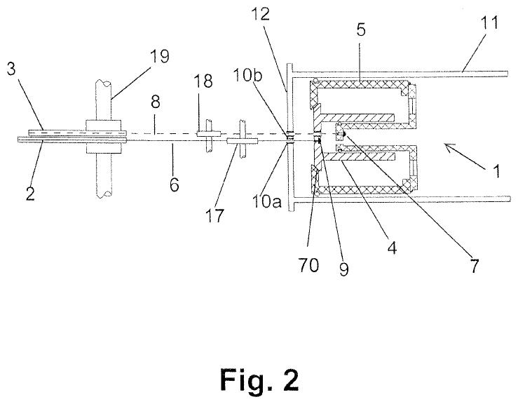

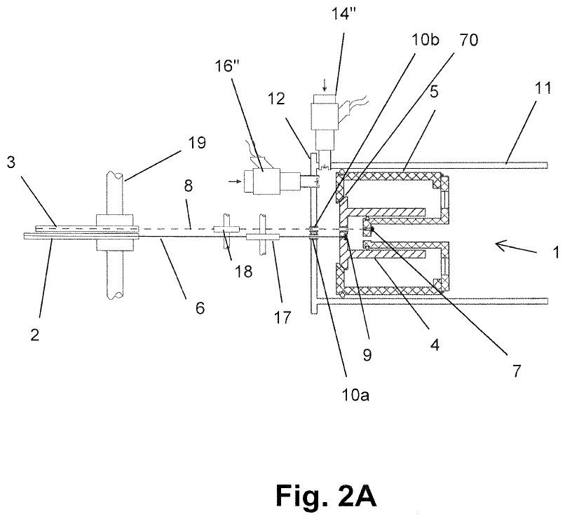

Referring to FIGS. 1A through 1F and FIG. 2, the operation of the valved-piston assembly 1 is shown via a series of drawings describing the sequence of events occurring with the activation of a valved-piston assembly 1 relative to the 360-degree rotation of two camcrank assemblies 2, 3 (that is, the actuator) connected to the valved-piston assembly 1 such that the valved-piston assembly 1 drives two camcrank assemblies 2, 3 that rotates the drive shaft 19 that ultimately drivers a mechanical system requiring rotational power. It should be appreciated that only the power-band 6 drives the shaft 19 via the power camcrank 2. The exhaust-band 8 only activates the exhaust valve assembly 4 that is part of the valved-piston assembly 1.

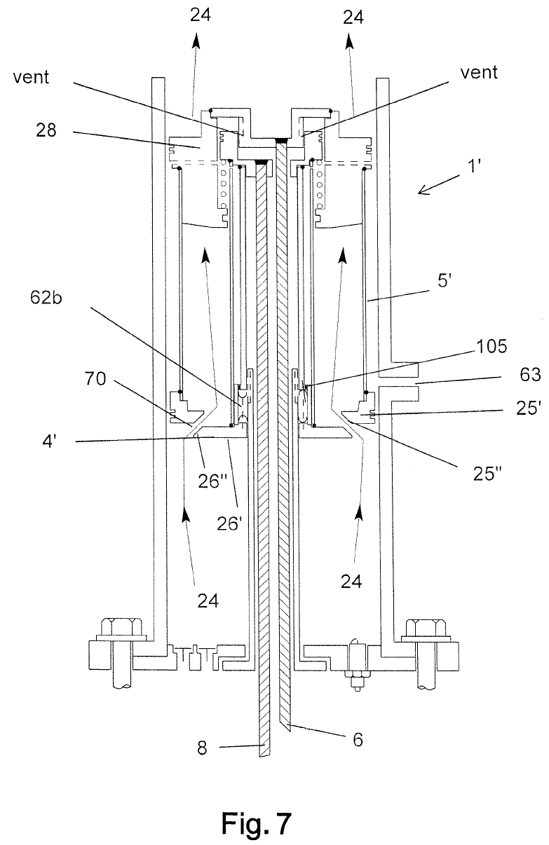

As briefly mentioned above, the first camcrank assembly is the “power-camcrank assembly” 2, and the second camcrank assembly is the “exhaust-camcrank assembly” 3, which is 15-degrees in advance rotational angle relative to the power-camcrank assembly 2. Again, as stated previously, it should be noted that the drawings shown in FIGS. 1A through 1H are for describing the operation of the invention of the valved-piston, including how the forces are transmitted and how the exhaust valve opens and closes during the 360 degree rotation of the crankshaft, and are not literal descriptions or representations of how the valved-piston assembly 1 and actuation mechanisms would be manufactured. For example, no consideration is being made in FIGS. 1A through 1H, or the descriptions thereof, of the ability to make reliable seals between components for containment of pressured gas or fluid, or abilities of materials to perform under the loading and wearing surfaces shown in FIGS. 1A through 1H. Also, the present valved-piston assembly does not rely on the shorter stroke or the 15-degree advancement of the exhaust-camcrank 8 assembly because the valve opening could be accomplished with the application of a variable timing cam, see FIG. 1G. Again, the illustration of FIGS. 1A through 1G are for communicating the operation of the valved-piston assembly and actuation functions. FIG. 1A shows the power-camcrank assembly 2 engaged to a centrally located exhaust-valve assembly 4 of the valved-piston assembly 1 via a flexible power-band 6 that is firmly connected to the exhaust-valve assembly 4 at the exhaust-valve fixation point 7. Also shown is an exhaust-camcrank assembly 3 engaged to the main piston body 5 via a flexible exhaust-band 8 that is firmly connected to the main piston body 5 at the piston-body fixation point 9. Both the exhaust-valve assembly 4 and the main piston body 5 are part of the same valved-piston assembly 1. It is noted that the flexible exhaust-band 8 slips through the exhaust-valve assembly 4 at an exhaust-valve assembly seal bushing 4b in the exhaust valve assembly 4 to allow free movement of the flexible exhaust-band 8 and a perfect seal via seal bushing 4b, and both the flexible power-band 6 and the flexible exhaust-band 8 are allowed free movement and a perfect seal via seal bushings 10a and 10b, respectively (note: this is for illustration purposes to communicate the operation of the valved-piston mechanism and not for actual production of the product). It should be noted FIGS. 1A to 1F show a single flexible power-band 6 for the purpose of simplifying the disclosure. However, and as shown in FIGS. 3, 3A, 3B, 3C, and 4, a construction with dual flexible power-bands would be appropriate for use in accordance herewith. Although not used in this example of the sequence of events shown in 1A through 1F, in an inverse manner, it is an option to connect the flexible power-band 6 to the main piston body 5 and to connect the flexible exhaust-band 8 to the exhaust-valve assembly 4, where the descriptions of the mechanism of operation described in the sequence of event, would be inversed accordingly, as illustrated in FIG. 7 and described accordingly.

FIG. 1A shows the power-camcrank assembly 2 and valved-piston assembly 1 at 0-degrees rotation (bottom-dead-center “BDC”) of the 360-degrees rotation. In accordance with the present valved-piston assembly, bottom-dead-center of the power-camcrank assembly 2 is the beginning of the power stroke.

It is further shown in FIG. 1A that the valved-piston assembly 1 is installed in a cylinder 11 with a cylinder-plate assembly 12 on one end 11a of the cylinder 11 and an atmospheric opening port 13 on the other end 11b of the cylinder 11. The cylinder-plate assembly 12 could be made in a manner to minimize heat transfer, either with coatings, air pockets, or made of thermally insulating material such as ceramic materials, which minimized heat transfer from combustion surfaces. On the cylinder-plate assembly 12, there is a fuel-intake-port 14, an oxidizer-intake-port 16, and a sparkplug 15. It is noted that the flexible power-band 6 slips through the power-band bushing 10a, and the flexible exhaust-band 8 slips through the power-band seal bushing 10b and the exhaust-valve assembly seal bushing 4b, to allow a free movement of the flexible power-band 6 and the flexible exhaust-band 8 and a perfect seal (note: this is for illustration purposes to communicate the operation of the valved-piston mechanism and not for actual production of the product). Mechanisms for sealing the combustion chamber are shown in later embodiments, including FIGS. 3 through 5, FIG. 7 and FIG. 8, with descriptions accordingly.

FIG. 1A further shows the power-band idler assembly 17, which guides the flexible power-band 6 and provides a fixed and non-restrictive pivot point for motion of the flexible power-band 6. Also shown is the exhaust-band idler assembly 18, which guides the flexible exhaust-band 8 and provides a fixed and non-restrictive pivot point for motion of the flexible exhaust-band 8. Also shown in FIG. 1A is the set of releasable-and-adjustable-band-anchor-points 27 that are individually connected to both the flexible power-band 6 and the flexible exhaust-band 8, that can be either mechanically or electronically activated to adjust position, tension, or fixation in a constant, variable, or intermittent manner.

FIG. 1A further shows the power-camcrank assembly 2, that is mounted on a drive shaft 19, in the forefront. A second camcrank assembly, the exhaust-camcrank assembly 3, is shown mounted on the same drive shaft 19, however, the exhaust-camcrank assembly 3 is mounted immediately behind the power-camcrank assembly 2. Again, for the purpose of the description of how the present valved-piston works, the exhaust-camcrank assembly 3 is 15-degrees in advance rotational angle compared to the power-camcrank assembly 2, although the degree of advance or retardation on either camcrank assembly can be adjusted to various settings depending on the desired timing arrangements.

As described in U.S. Patent Application Publication No. 2014/0224116, both the power-camcrank assembly 2 and the exhaust-camcrank assembly 3 are not fixedly attached to the flexible membranes, that is, the flexible power-band 6 and the flexible exhaust-band 8, respectively. The connecting membranes, the flexible power-band 6 and the flexible exhaust-band 8, only engage their respective camcrank assemblies 2, 3 if there is pulling tension in the respective flexible membranes defined by the flexible power-band 6 and the flexible exhaust-band 8 they will each respectively engage the camcrank mechanism. As described in US Patent Application Publication No. 2014/0224116, there are bearing surfaces, the power-camcrank-bearing 20 and the exhaust camcrank-bearing 21, that allow free unrestricted rotation of the power camcrank-ring 22 and the exhaust camcrank-ring 23.

FIG. 1A shows the initiation of the power stroke stage of the valved-piston assembly 1, occurring at or approximately bottom-dead-center (BDC), or 0-degrees, of the power-camcrank assembly 2 rotation. At this stage of the cycle, the sparkplug 15 has just ignited a fuel/oxidizer mixture and combustion gas 24 is expanding. The surfaces that are contacted by the combustion gases, including all surfaces of the valved-piston assembly 1, the cylinder 11 and the cylinder-plate assembly 12, could be made in a manner to minimize heat transfer, either with coatings, air pockets, or made of thermally insulating material such as a ceramic materials, that minimized heat transfer from combustion surfaces.

Referring now to FIG. 1B, the power-camcrank assembly 2 is shown at 90-degrees clockwise rotation from bottom-dead-center. The valved-piston assembly 1 is approximately half-way through the power stroke and the combustion gas 24 is causing work to be done at the drive shaft 19. The exhaust-valve assembly 4 is closed due to closing force caused by combustion gas 24 pressure on the frontal piston-body surface area 25 portion of the valved-piston assembly 1 causing tension in flexible power-band 6 connected to the power-camcrank assembly 2. It should be appreciated that in the disclosed embodiment, the frontal piston-body surface area 25, is about four times greater that the frontal exhaust-valve surface area 26, with tension on the flexible power-band (and no tension or slack 8′ on the exhaust-band 8), resulting in a net resultant force that forcibly closes the main piston body 5 against the exhaust-valve assembly 4, preventing combustion gas 24 from escaping.

FIG. 1C shows the power-camcrank assembly at 15-degrees before top-dead-center (TDC). At this position, the exhaust-camcrank assembly 3 has reached top-dead-center, and full tension has been transferred from the flexible power-band 6 to the flexible exhaust-band 8, causing the main piston body 5 to stop further travel in the direction of the power stroke. At approximately this point in the travel of the valved-piston assembly 1, there is a transfer of tension from the flexible power-band 6 to the flexible exhaust-band 8 and power-band slack 6′ is beginning to occur in the flexible power-band 6, and the exhaust-valve assembly 4 is free to open.

FIG. 1D shows the power-camcrank assembly 2 at 180-degrees, top-dead-center (TDC) of the power-camcrank assembly 2 rotation. At this position, the exhaust-camcrank assembly 3 is 15-degrees in advance of the power-camcrank assembly 2, and full tension is in the flexible exhaust-band 8, pulling on the main piston body 5 and fully opening the exhaust-valve assembly 4 by separating the exhaust valve plate 26′ and the exhaust valve seat 26″ of the exhaust-valve assembly 4 from the piston body bottom plate 25′ and the piston body exhaust valve seat 25″ of the main piston body 5 to create a passageway for the exhaust gas 24, pulling the entire valved-piston assembly 1 down, and exhausting combustion gas 24 from the cylinder 11. Because the power-camcrank assembly 2 rotation is behind the rotation of the exhaust-camcrank assembly 3, there is slack in the flexible power-band 6.

FIG. 1E shows the exhaust-camcrank assembly 3 at approximately 315-degrees. At approximately this position, due to the increased speed of the power-camcrank assembly 2 (due to its longer stroke), the exhaust-valve assembly 4 has “caught up” to the piston-body 5 portion of the valved-piston assembly 1, seamlessly transferring tension from the flexible exhaust-band 8 to the flexible power-band 6, which causes the exhaust-valve assembly 4 to close against the main piston body 5 and make a positive seal. At this point all, or at least a majority, of the combustion gas 24 has been exhausted. At this point, and during the remaining distance of the downward stroke, fuel 14′ and oxidizer 16′ can be injected and compressed for the next power stroke. Because the flexible power-band 6 is advancing the movement of the valved-piston assembly 1, by means of the advancing power-camcrank assembly 2, there is slack 8′ beginning to form in the flexible exhaust-band 8.

At this point of the downward stroke of the valved-piston assembly 1, at approximately 315-degrees, the valved-piston assembly 1 is approaching the cylinder-plate assembly 12 with a potentially high velocity. So far in this example of the sequence of events there has not been described a mechanism that would prevent the valved-piston assembly 1 from unrestrained impact with the cylinder-plate assembly 12, other than the injection of fuel 14′ and oxidizer 16′. In the event the fuel 14′ and/or oxidizer 16′ are compressed gas, the further compression of the gas(es) after injection would create a counter force, or impact buffer, to prevent detrimental impact of the valved-piston assembly 1 against the cylinder-plate assembly 12. The precise timing of the injection of fuel 14′ and/or oxidizer 16′, and their ignition, could eliminate detrimental impact between the valved-piston assembly 1 and the cylinder-plate assembly 12 (for example, in the case of a diesel-like combustion, where oxidizer 16′ (in the form of compressed air or nearly pure oxygen) was injected at 315-degrees rotation then further compressed to a high pressure-temperature, where upon injection of the fuel 14′ results in spontaneous ignition of the fuel causing a violent explosion (combustion commencing the power stroke) that prevents the valved-piston assembly 1 from impacting the cylinder plate). In this case, the energy from the momentum of the rapidly moving valved-piston assembly 1 is conserved, that is, the energy of the rapidly moving valved-piston assembly 1 is converted from kinetic energy to the potential energy of the compressed fuel 14′ and oxidizer 16′, contributing to the efficiency of the engine. The same example can be made with the injection of any oxidizer 16′ and fuel 14′ combinations, including air/liquid-gasoline, or air/combustible-gas combination. Advances in the electronically controlled common rail and direct injection of internal combustion engines, with electronic position sensors (not shown in drawings) mounted directly on the valved-piston assembly 1, would allow for controlling the timing of combustion to prevent detrimental impact of the valved-piston assembly 1 with the cylinder-plate assembly 12, in the manner described above.

Based on the sequence of events described above, there are combustion gases remaining in the combustion chamber from the previous combustion event. This combustion gas would include water vapor in the case of using pure hydrogen (fuel) and pure oxygen (oxidizer). Or, the combustion gas would include a blend of nitrogen, water vapor, and carbon dioxide, in the case of using hydrocarbon (fossil fuel) and air (oxidizer-oxygen component of air). Or, the combustion gas would include water vapor and carbon dioxide, in the case of using hydrocarbon (fossil fuel) and pure oxygen (oxidizer).

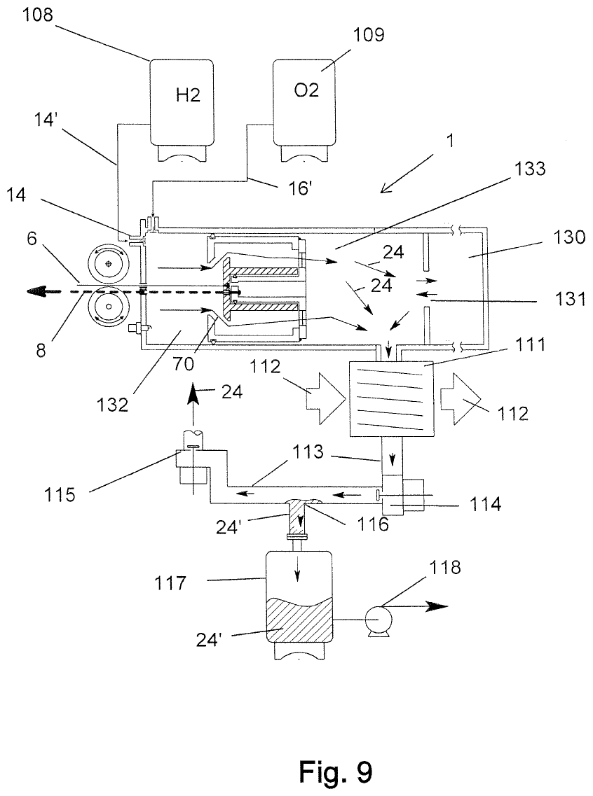

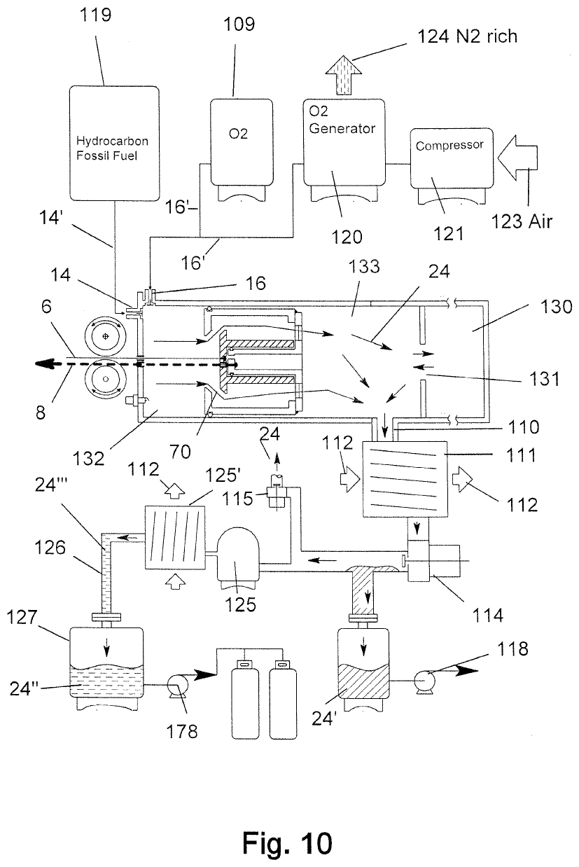

FIGS. 9 and 10 show the process stream for the Recycled Combustion for combusting nearly pure hydrogen and oxygen, and combusting a hydrocarbon fuel with nearly pure or concentrated oxygen, where the pressure of combustion (compression ratio) is infinitely variable.

FIG. 1F shows the exhaust-camcrank assembly 3 at 360-degrees (or 0-degrees). At this position, the power-camcrank assembly 2 is 15-degrees behind in rotation, and full tension is in the flexible power-band 6. Fuel 14′ and oxidizer 16′ have been injected, and with a spark from the sparkplug 15, the next power stroke as shown in FIG. 1A, is ready to commence, at or around bottom-dead-center of the stroke of the power-camcrank assembly 2. Because the flexible power-band 6 is in contact and advancing the movement of the valved-piston assembly 1, there is slack 8′ in the flexible exhaust-band 8.

FIG. 1G shows an alternative method of actuating the exhaust-valve assembly 4 by means of rotating cam timing system with variable valve timing and/or variable band length adjustment mechanism.

In reference to FIG. 1G, another embodiment of the valved-piston assembly is disclosed including an exhaust cycle that is actuated by a rotating exhaust cam 100. In this embodiment of the valved-piston assembly, the rotating exhaust cam has a cam lobe 101 that makes direct contact with the flexible exhaust-band 8 in a region between two exhaust cam idlers 102, effectively shortening the length (or increase, depending on desire of the valve timing) of the flexible exhaust-band 8. Adjusting the length of the flexible exhaust-band 8 essentially affects the timing of the opening and closing of the exhaust-valve assembly 4 to open or close at any point in the downward travel of the valved-piston assembly 1, from top-dead-center to bottom-dead-center, due to the ability to change the position of the exhaust-valve assembly 4 relative to the position of the main piston-body 5. For example, although the rotational velocity of the two components may be 1000 rpm, the configuration of the mechanism highlighted in FIG. 1G shows that the relative position of the exhaust-valve assembly 4 relative to the motion of the main piston-body 5 can be infinitely varied between full-open and full-closed (typically a distance of zero to 15 mm) by simply adjusting the length of the flexible exhaust-band 8.

As disclosed in FIG. 1G, the timing of the contact of the cam lobe 101 with the flexible exhaust-band 8 can be infinitely adjusted between zero and full-contact by means of a variable cam timing mechanism 103, common to many internal combustion engines. Also shown in FIG. 1G is a band length adjuster and anchor 104, that provides a real-time mechanism for adjusting length of the flexible exhaust-band 8, and provides a fixture, or anchor, to counteract the tension on the flexible exhaust-band 8.

This ability to affect the opening or closing of the exhaust-valve assembly 4 at any point in the downward travel of the valved-piston assembly 1, creates an infinitely variable compression ratio for the ensuing combustion of the fuel 14′ and oxidizer 16′. Having the ability to infinitely vary the compression pressure from a range of 5 to 35 bar enables a wide range of fuel options, with higher power outputs and efficiencies.

The same cam timing mechanism and band length adjustment mechanism shown in FIG. 1G could be applied to the flexible power-band 6. Changing the length of the power-band 6 changes the amount of compression done during the compression cycle, or compression portion of the 360-degree rotation, by adjusting how far “down” the valved-piston assembly 1 will travel toward the cylinder-plate assembly 12 while the exhaust-valve 4 is closed. For example, the amount of compression could be varied from a maximum compression caused by adjusting the length of the power-band 6 to result in near zero clearance between the valved-piston assembly 1 and the cylinder-plate assembly 12 at bottom-dead-center of the compression cycle (absolute zero clearance would be impossible without mechanical damage to the components), to about 12.5 mm of clearance between the valved-piston assembly 1 and the cylinder-plate assembly 12 at bottom-dead-center of the compression cycle. The clearance of 12.5 mm between the valved-piston assembly 1 and the cylinder-plate assembly 12, for a valved-piston 1 diameter of 150 mm with a fixed-exhaust-guide stanchion 28 diameter of 25 mm, and a closed-valve compression distance of 100 mm, would result in a compression ratio of 8:1, which is a common compression ratio for internal combustion engines. Again, shortening the length of the power-band 6, in real-time during the operation of the engine, would allow an infinitely variable compression ratio between 8:1 (in this example) and whatever maximum desired. A common diesel engine, for example, typically operates with a compression ratio of 20:1, or higher.

The same cam timing mechanism and band length adjustment mechanism shown in FIG. 1G could be applied to the flexible power-band 6. The present valved-piston assembly also includes consideration of other means of adjusting the power or exhaust band length through the mechanisms shown, including varying the distance between the exhaust cam idlers 102, the use of electro or hydraulic actuators, and position sensors (not shown).

FIG. 1H shows an alternative configuration where the conventional power crankshaft journal 2′ is connected to the flexible power-band 6′, and an exhaust-camcrank 3 is connected to the flexible exhaust-band 8.

In reference to FIG. 1H, the same embodiment for the rotating exhaust cam 100 is shown as that of FIG. 1G, however, in FIG. 1H, the rotation of the power crankshaft journal 2″ is rotated about 90-degrees, and is therefore in the middle of the power stroke. The location of the valved-piston assembly 1 is at about the middle of its upward travel in the cylinder 11, and the exhaust-valve 4 is in its closed position. The rotating exhaust cam lobe 101 is not making contact with the flexible exhaust-band 8, effectively lengthening the length of the flexible exhaust-band 8, therefore there is slack 6′ in the flexible exhaust-band 8. As described in FIG. 1G, adjusting the length of the flexible exhaust-band 8 essentially affects the timing of the opening and closing of the exhaust-valve assembly 4 to open or close at any point in the downward travel of the valved-piston assembly 1, from top-dead-center to bottom-dead-center, due to the ability to change the position of the exhaust-valve assembly 4 relative to the position of the main piston-body 5.

As disclosed in FIG. 1H, the timing of the contact of the cam lobe 101 with the flexible exhaust-band 8 can be infinitely adjusted between zero and full-contact by means of a variable cam timing mechanism 103, common to many internal combustion engines. Also shown in FIG. 1G is a band length adjuster and anchor 104, that provides a real-time mechanism for adjusting length of the flexible exhaust-band 8, and provides a fixture, or anchor, to counteract the tension on the flexible exhaust-band 8.

Referring to FIG. 2, it is a top view of FIGS. 1A through 1F showing the camcrank mechanisms, bands, and valved-piston assembly 1. Also shown in FIG. 2A are the placement of the electronic fuel injector 14″ and oxidizer injector 16″. In consideration of the timing of the injection of the fuel 14′ and oxidizer 16′, the inherent free-spin capability of the camcrank device allows the on-off capability for each individual piston by simple control of the injection of the fuel injector 14″ and oxidizer injector 16″. For example, by simply electronic shut-down of the fuel injector 14″ at the fuel intake port 14 and shutting down of the oxidizer injector 16″ at oxidizer intake port 16, each piston can be disengaged for as many cycles as desired. As previously described, this simple on-off control of each cylinder allows the engine to run as 2-stroke, 4-stroke, 8-stroke, 16, stroke, or any desirable on-off firing pattern, with no mechanical alterations required of basic crankshaft mechanism. It is evident from the capabilities described above, the importance of electronic injection of both fuel 14′ and oxidizer 16′, along with electronic position sensors and microcontrollers, allows for great opportunities for diverse engine control and increases in efficiencies.

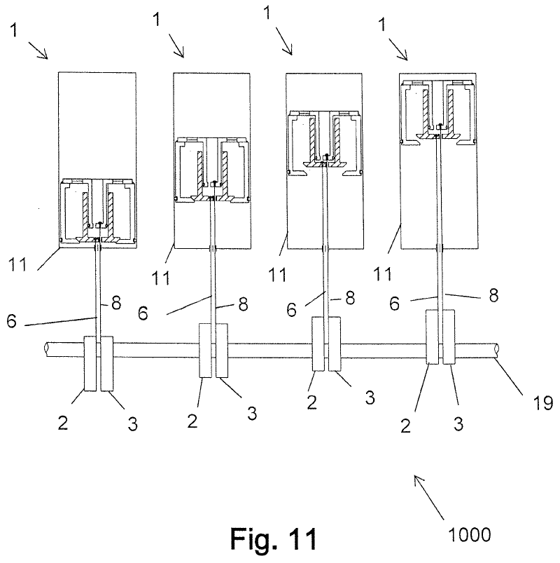

With the foregoing in mind, a camcrank would be capable of spinning relative to the belts and the piston considering the lack of a fixed connection therebetween. For example, and with reference to FIG. 11, in the event one of the cylinders ceased operation the various camcranks would be able to continue rotating under the power provided by the other cylinders.

Referring to FIGS. 3, 3A, 3B, 3C, 4, and 5, detailed sectional views through another disclosed embodiment of the valved-piston assembly 1 are provided. FIG. 3 shows the valved-piston assembly 1 in the closed exhaust valve position, with movement constraints, pressurized valve closure bias caused by full pressure lubrication, seal locations, and exhaust gas passages. It is noted that the valve closure bias can be achieved using a spring mechanism. FIG. 4 shows the valved piston assembly with the exhaust-valve in the fully open position, with movement constraints, pressurized valve closure bias, seal locations, and exhaust gas passage. FIGS. 3A, 3B, and 3C are detailed sectional views of the components of the valved-piston assembly 1. It should be appreciated that similar reference numerals are used in describing this embodiment.

FIG. 3A is one embodiment of the valved-piston assembly showing a fixed exhaust guide stanchion 28. The fixed exhaust guide stanchion 28 is the means of providing both a fixed guide for movement of the exhaust-valve assembly 4, but also a perfect or near-perfect sealing surface for the sealing mechanism, that is the dynamic seal, the sealing mechanism 62b of exhaust-valve assembly 4, shown in FIG. 3C and FIGS. 4 and 5. It should be noted that another option is to make the exhaust guide stanchion non-fixed, or dynamic, by it being a fixed part of the exhaust-valve assembly 4, wherein the sealing mechanism would be fixed to the cylinder-plate assembly 12, and the exhaust guide stanchion would reciprocate with the motion of the exhaust-valve assembly 4 (this option is not shown in the drawings).

FIG. 3B is one embodiment of the valved-piston assembly 1 showing the main piston body 5 portion of the valved-piston assembly 1. FIG. 3B shows the piston body bottom plate 25′, the piston body exhaust valve seat 25″, the piston body upper plate 28, the piston body flanged member 61a, the piston body extension tube 5′, and the dynamic seals 62a, 62c. Also shown is the flexible exhaust-band 8 and the exhaust band fixation point 9.

FIG. 3C shows the exhaust-valve assembly 4, with components including the exhaust valve plate 26′, the exhaust valve seat 26″, the flanged member 61b, the dynamic seal 62b, and dynamic seal 62d. Also shown are the inner extension tube 4′ and outer extension tube 4″ of the exhaust valve assembly 4, that create an exhaust valve annulus 4″′ that provides a path for pressurized lubrication and cooling. Further shown are two flexible power-bands 6, that are symmetrically positioned to avoid bending moments occurring in the exhaust-valve assembly 4 during loading. Also shown are the corresponding two power band fixation points 7. As discussed above, the exhaust valve plate 26′ and the exhaust valve seat 26″ of the exhaust-valve assembly 4 move relative to the piston body bottom plate 25′ and the piston body exhaust valve seat 25″ of the main piston body 5 to create a passageway for exhaust gas.

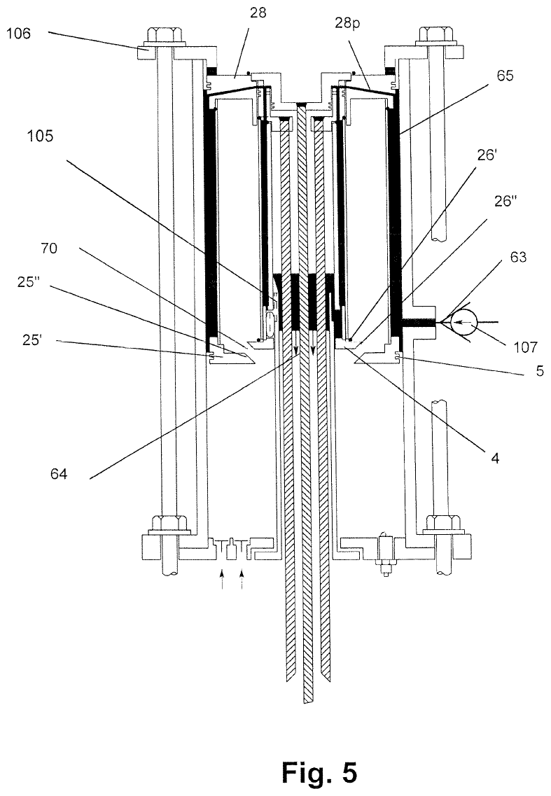

FIG. 4 shows the valved piston assembly with the exhaust-valve in the fully open position, including the direction and flow of the exhaust gas 24, the two power band fixation points 7, and the exhaust band fixation point 9. Also shown is the full pressure lubrication (and cooling) inlet port 63. Further descriptions of the full pressure lubrication (and cooling) are described below in conjunction with the embodiments disclosed with reference to FIGS. 5, 7, and 8.

Also shown in FIG. 4 is a piston-stop 106 that limits the travel distance of the valved-piston assembly 1. The piston-stop 106 is secured at the upper end 11a of the cylinder 11. It is noted that the impact of the valved-piston assembly 1 with the piston-stop 106, would occur at the main-piston-body 5, with the continued upward travel of the exhaust-valve assembly 4, thereby causing an exhaust-valve opening 70 of the exhaust-valve assembly 4 relative to the main piston body 5. Based on this configuration of the impact and valve opening, occurring near top-dead-center, it is possible a more crudely designed engine could be operated with a single power-camcrank 2 and flexible power-band 6, without the need for an exhaust-camcrank 3 and flexible exhaust band 8. Design options could include the use of electro or hydraulic pressure actuators to open and close the exhaust-valve assembly 4, with or without the piston-stop 106.

FIG. 5 shows additional details relating to the full pressure lubrication (and cooling) inlet port 63, and the lubrication (and cooling) outlet port 64. It is noted that the outlet port 64 releases to lubrication and cooling fluid 65 down into the fixed exhaust valve guide stanchion 28, at near atmospheric pressure where the lubrication and cooling fluid 65 drains down to the crankcase of the engine (not shown in drawing). It is noted here that the full pressure lubrication also provides cooling of the cylinder 11 and the valved-piston assembly 1.

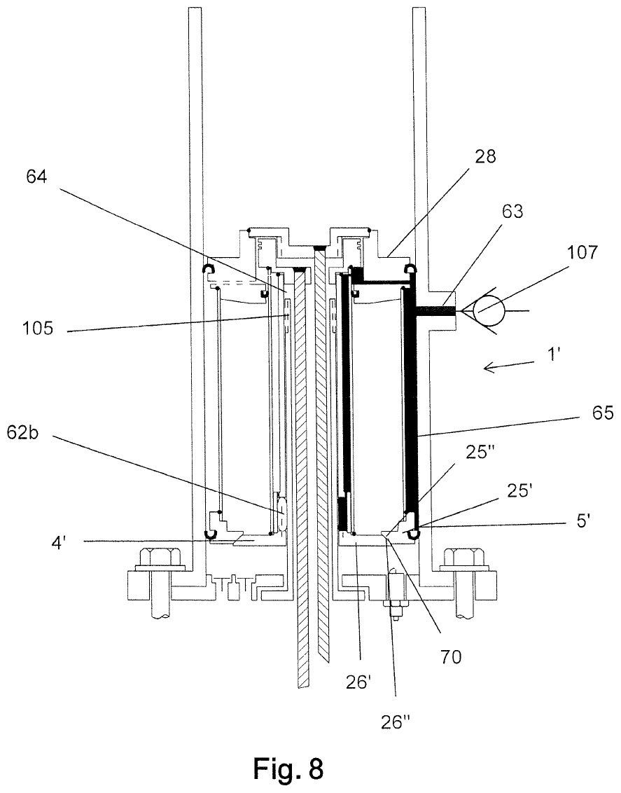

FIG. 5 also shows the pressurized valve closure bias caused by full pressure lubrication, and the cooling circuit offered by the full pressure lubrication. FIG. 5 shows the valved-piston assembly 1 in the top-dead-center position. At the top-dead-center position of the valved-piston assembly 1, the station oil release port 105 at the top of the fixed exhaust valve guide stanchion 28 (see FIGS. 3A, 4, and 5) vents and releases the lubricating and cooling fluid 65 into the outlet port 64. This venting releases some of the lubrication and cooling fluid 65 which partially reduces pressure which assists in the opening of the exhaust-valve assembly 4. In contrast, as the valved-piston assembly 1 approaches the bottom-dead-center position of the compression phase, there is a near perfect seal at dynamic seal 62B, which seals the lubricating oil from further flow, assisting the closing of the exhaust-valve assembly 4, and prevents high pressure combustion gases from escaping out of the combustion chamber and into the high pressure lubricating fluid 65. More details regarding this process are shown in FIG. 8 and the below description associated therewith.

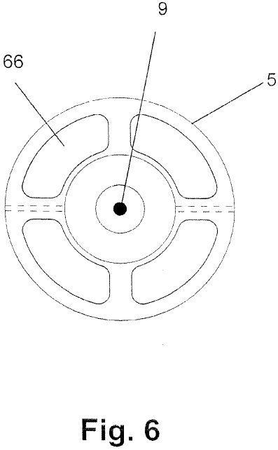

FIG. 6 shows a top view of the main piston body 5 and the piston body exhaust ports 66. Also shown is the exhaust band fixation point 9, as it relates to FIGS. 1A-1G.

FIG. 7 shows an alternate of the valved-piston assembly 1′ where the exhaust-camcrank 3 is connected to the exhaust-valve assembly 4 of the valved-piston assembly 1′, by means of a single flexible exhaust-band 8, and the power-camcrank 2 is connected to the main piston-body 5′, by means of a single flexible power-band 6. This configuration is opposite the flexible band configuration shown in FIGS. 1A-G. Similarly, the embodiments disclosed with reference to FIGS. 7 and 8 provide an exhaust-valve opening 70 with the respective valve seats 25″, 26″ oriented in a direction opposite that shown in the embodiment of FIGS. 1A-1F, 2, 3, 4, and 5. In particular, the valve seats 25″, 26″ are oriented at an acute angle relative to a longitudinal axis of the cylinder in the embodiment of FIGS. 7 and 8 (when measured on the side of the cylinder 11 closest to the camcranks), and the valve seats 25″, 26″ are oriented at an obtuse angle relative to a longitudinal axis of the cylinder in the embodiment of FIGS. 1A-1F, 2, 3, 4, and 5 (when measured on the side of the cylinder 11 closest to the camcranks).

In disclosing this embodiment of the valved-piston assembly 1′, it has been described using the flexible band configuration described in FIGS. 1A-1G as a preferred embodiment of the valved-piston assembly for specific reasons. One of these specific reasons include the apparent advantage of minimizing structural requirements (and associated weight gains) of the main piston-body 5 to accommodate the loads caused by the high-pressure combustion during the power stroke. The ongoing evaluation of prototype engines will help determine which configuration is ideal, however, the current consensus is that each configuration will have advantages and disadvantages relative to the specific application.

As described above in conjunction with FIG. 4, there is an opportunity to add a piston-stop 106 in the embodiment disclosed in FIG. 5. In the configuration shown in FIG. 5, with a piston-stop 106 (not shown in FIG. 5) impacting the exhaust-valve assembly 4 there could be a mechanism for this impact to open and close the exhaust-valve assembly 4″ at or near top-dead-center of the piston travel. Similar to the description for FIG. 4, it is possible a more crudely designed engine could be operated with a single power-camcrank 2 and flexible power-band 6, without the need for an exhaust-camcrank 3 and flexible exhaust band 8. Design options could include the use of electro or hydraulic pressure actuators to open and close the exhaust-valve assembly 4.

In reference to FIG. 8, further detail is shown on the pressurized oil lubrication and cooling of the valved-piston assembly 1′, as it relates to the configuration shown in FIG. 7, including a mechanism of producing an on-off oil flow and pressure control of the lubricating oil. In a similar manner as explained in the exhaust-valve assembly 4 configuration shown in FIG. 5, there is a pressurized valve closure bias caused by full pressure lubrication, and the cooling circuit offered by the full pressure lubrication. FIG. 8 shows the valved-piston assembly 1′ in the bottom-dead-center position. At the bottom-dead-center position of the valved-piston assembly 1′, the oil release port 105 of the fixed exhaust valve guide stanchion 28 (see FIGS. 3A, 4, and 5), is at the opposite end of the dynamic seal 62B, therefore allowing the dynamic seal to effect a near perfect seal. As the valved-piston assembly 1′ approaches the bottom-dead-center position of the compression phase, there is a near perfect seal at dynamic seal 62B, which seals the lubricating oil from further flow, assisting the closing of the exhaust-valve assembly 4, and prevents high pressure combustion gases from escaping out of the combustion chamber and into the high-pressure lubricating fluid 65. Again, as described in the description of FIG. 5, at the top-dead-center position of the valved-piston assembly 1′, the stanchion oil release port 105 opens for the flow of the pressurized lubrication and cooling into the outlet port 64. The use of oil pressure to effect on-off action of the exhaust-valve assembly 4 using electrohydraulic actuators can be incorporated in the pressurized lubrication and cool circuit. A check valve 107 is shown to address back pressure that would occur during the high pressure caused by combustion.

FIG. 9 shows the process stream for the Recycled Combustion process for combusting nearly pure hydrogen and oxygen, where the pressure of combustion (compression ratio) is infinitely variable, and the combustion product (water) is condensed and recycled to an electrolyzer or other use. The means of producing an infinitely variably combustion pressure, from zero bar pressure to some maximum value of pressure, is by means of the exhaust-valve assembly 4 open and close timing and the back pressure adjustments described previously in this application. It is noted that the term “pure” or “nearly pure” are to indicate an ideal condition, and it is expected that there are both physical and practical limitations in achieving a purity and varying purities of oxidizers or reducing agents are tolerable in the Recycled Combustion process described herein. The following discussion related to FIG. 9 provides additional descriptions of the means of controlling the back pressure that is the combustion process of the valved-piston assembly.

In reference to FIG. 9, a flow scheme is depicted showing a source of hydrogen gas from a hydrogen reservoir 108 and a source of oxygen from an oxygen reservoir 109 being supplied to the fuel-intake-port 14 and oxidizer-intake-port 16, respectively, of a combustion engine incorporating a valved-piston assembly 1. As described in the preceding sections of this application, the configuration of the valved-piston assembly allows for the compression and combustion of the fuel and oxidizer mixture. In FIG. 9, the valved-piston assembly 1 is shown in the exhaust phase of the combustion cycle, and the combustion gases 24 are shown existing through the exhaust port 110. As to the specific embodiment of the valved-piston assembly 1 used in the embodiment of FIG. 10, either of the various embodiments disclosed above may be used.

As further shown in FIG. 9, the exhaust gases 24 pass through the exhaust port 110 and enter a condenser 111. There is a heat exchange fluid 112, probably air, that passes through the condenser 111, that transfers heat out of the exhaust gases 24 (without mixing the heat exchange fluid 112 with the exhaust gases 24, in the typical function of a condenser) removing the heat from the exhaust gases 24, in the normal manner of operation of a condenser 111. After exiting the condenser 111, the combustion gases, now at a reduced temperature, move downstream through a gas-liquid conduit 113, to a pressure-control valve 114. The purpose of the pressure-control valve 114, is to maintain a back pressure that is desirable for the operation of the Recycled Combustion Engine, including the amount of back pressure to help achieve the desired compression in the combustion chamber (variable compression) and achieve the desired lower relative pressure on the condenser side 133 of the valved-piston assembly 1, maintain a pulling force enacted on the power-band 6. The pressure-control valve 114 also controls the desirable pressure and temperature conditions (by means of flow regulation) in the condenser 111 to cause liquification of the combustion gases 24, which in this case is the desire to produce nearly pure water condensate 24′ downstream of the condenser 111. Under normal operation of the Recycled Combustion Engine, it is expected that the state of the phase of the combustion gases 24 downstream of the condenser 111, barring any contaminants, would include both vapor phase combustion gas 24 and nearly pure water condensate 24′ derived from the combustion gas 24. Also, it is likely that efforts to condense the combustion gases 24 would further benefit from additional heat exchangers or condensers downstream of the pressure-control valve. For further pressure and temperature control (by means of flow regulation) a pressure-control vent 115 can be installed at the end of the process stream to provide the ability to vent combustion gases 24 to the atmosphere after passing through the condenser 111, or after passing through the pressure-control valve 114.

As further shown in FIG. 9, the water condensate 24′ moves past the pressure-control valve 114 to a tee 116 that is installed in the gas-liquid conduit 113 to allow gravitational settling out of the water condensate 24′ into a water storage reservoir 117. The water condensate 24′ that is collected in the water storage reservoir 117 can be stored or transferred by a condensate pump 118 for reuse in the appropriate manner. One application of the recycled water is to use it as a feedstock for an electrolyzer (not shown) for the generation of nearly pure hydrogen and oxygen gas using electrical power generated from a renewable source. In this way the electrical energy from the renewable sources (wind and solar power) can be stored, in the form of hydrogen and oxygen, typically as a compressed gas, but also as a compound, hydride, or as a liquid using cryogenics. The stored hydrogen and oxygen could then be fed back into the Recycled Combustion Engine flow scheme as source gases at the hydrogen reservoir 108 and the oxygen reservoir 109.

For clarification regarding the flow stream described as Recycled Combustion, it is understood that not all the combustion gas 24 resulting from the combustion of the fuel (nearly pure hydrogen gas in this example) and oxidizer (nearly pure oxygen gas in this example), must immediately be transferred through the condenser 111. To better illustrate the combustion process, an expansion volume 130 and an expansion volume passage 131 are shown immediately downstream of the valved-piston assembly 1. Combustion gas 24 exits the combustion chamber side 132 of the valved-piston assembly 1 during the initial opening of the exhaust-valve assembly 4 at the end of the power stroke. As previously described in this application, due to the action of a separately timed exhaust-camcrank 3, the exhaust valve assembly 4 remains in an open position, that is, the exhaust-valve opening 70 is open, for a predetermined amount of time during the downward motion of the valved-piston assembly 1, causing additional combustion gas 24 to exit the combustion chamber side 132 of the valved-piston assembly 1 and enter the condenser side 133 of the valved-piston assembly 1. When the exhaust-valve assembly 4 closes, the downward motion of the valved-piston assembly 1 creates a low pressure (relative low pressure) at the condenser side 133 of the valved-piston assembly 1, where this lower pressure draws combustion gas 24 from the expansion volume 130 through the expansion volume passage 131 (as noted below, there is not a check-valve shown between the condenser side 133 of the valved-piston assembly 1 and the condenser 111, however, those skilled in the art of gas and condensate flow would recognize the standard practice of using check-valves and flow restricting devices for desired gas and condensate flow regulation). In a reverse manner, during the beginning of the combustion stroke, with the valved-piston assembly 1 at near bottom-dead-center, with the exhaust-valve assembly 4 closed, the upward motion of valved-piston assembly 1 causes a higher pressure on the condenser side 133 of the valved-piston assembly 1, where this higher pressure pushes combustion gas 24 into the expansion volume 130 through the expansion volume passage 131. The net result of the described motion valved-piston assembly 1 and the timed opening and closing of the exhaust-valve assembly 4, is that the combustion gases recycle back and forth between the condenser side 133 of the valved-piston assembly 1 and the expansion volume 130 without having to fully flow into, out, or through the condenser 111. It is noted that this back and forth between the condenser 111 side of the valved-piston assembly 1 and the expansion volume could also happen between the condenser side 133 and the volume space created by additional tubing that is part of the exhaust port 110, and no separate expansion volume 130 or expansion volume passage 131 is required (however, the explanation using the expansion volume is useful for illustrating the operation of the Recycled Combustion Engine).

To give an example of the volumes associated with the disclosed embodiments, if an engine power requirement has an hourly consumption of 200 moles of hydrogen gas (fuel gas volume of 4,480 liters, at standard temperature and pressure), and 100 moles of oxygen gas (oxidizer gas at 2,240 liters, at standard temperature and pressure), the resulting condensate of combustion would be 1.8 liters of water per hour. This corresponds to volume of 30 cc per minute of liquid water condensate from condenser 111.

Based on the phase diagram equilibria diagram for pure water, it is known that the temperature and pressure conditions of 99 degrees Celsius and 1 bar (absolute), respectively, will result in condensation of combustion gas 24 to liquid water condensate 24′, and 125 degrees Celsius and 2 bar will result in condensation of the combustion gases 24 to a liquid water condensate 24′.

Referring to FIG. 9, it is for the sake of explaining the core components of the Recycled Combustion Engine that many necessary components are omitted, including valves, one-way check valves, pressure and flow regulators, filters, flow a pressure controls and sensors, additional condensers and heat exchangers, and control fixtures. The necessary components are normal to those skilled in the design of gas and condensate flow streams.

FIG. 10 shows the process stream for the Recycled Combustion for combusting a hydrocarbon fuel with pure or concentrated oxygen, where the pressure of combustion (compression ratio) is infinitely variable, as described in the prior paragraphs. The combustion products, including water and carbon dioxide, are condensed, and recycled, for reuse and carbon sequestration, respectively. As to the specific embodiment of the valved-piston assembly 1 used in the embodiment of FIG. 10, either of the various embodiments disclosed above may be used.

FIG. 10 shows the process stream for the Recycled Combustion process for combusting hydrocarbon fuels (typically liquid or gaseous fossil fuels but also synthetic hydrocarbons) and oxygen (absent of air and its nitrogen component), where the pressure of combustion (compression ratio) is infinitely variable, and the combustion products (water and carbon dioxide) are condensed and reused, recycled, or captured. As described in prior paragraphs, the means of producing an infinitely variably combustion pressure, from zero bar pressure to some maximum value of pressure, is by means of the exhaust-valve assembly 4 open and close timing and the back pressure adjustments described previously in this application. The following discussion related to FIG. 10 provides additional descriptions of the means of controlling the back pressure is the combustion process of the valved-piston assembly.

In reference to FIG. 10, a flow scheme is depicted showing the source of the fuel is a hydrocarbon from a hydrocarbon reservoir 119, and the source of oxygen from an oxygen reservoir 109, and/or an oxygen generator 120. A typical commercially available oxygen generator 120 separates oxygen from compressed air using a process called pressure swing adsorption (PSA). In PSA, the compressed air (typically 21% oxygen and 78% nitrogen) is allowed to flow through a zeolite molecular sieve which retains nitrogen resulting in the output of higher purity oxygen (up to and exceeding 95% oxygen). In FIG. 10, a compressor 121 is shown connected to the oxygen generator 120, by means of a compressed air conduit 122. An air source 123 is shown entering the compressor 121. A gaseous nitrogen waste stream 124 is shown exiting the oxygen generator 120.

Continuing with the description of FIG. 10, hydrocarbon fuel 14′ is supplied to the fuel-intake-port 14 and oxygen is supplied to the oxidizer-intake-port 16 of a combustion engine incorporating a valved-piston assembly 1. As described in the preceding sections of this application, the configuration of the valved-piston 1 assembly allows for the compression and combustion of the fuel and oxidizer mixture. In FIG. 10, the valved-piston assembly 1 is shown in the exhaust phase of the combustion cycle, and the combustion gases 24 are shown existing through the exhaust port 110, and/or back and forth between the condenser side 133 of the valved-piston assembly 1 and the expansion volume 130 by way of the expansion volume passage 131.

As further shown in FIG. 10, the exhaust gases 24 pass through the exhaust port 110 and enter a condenser 111. There is a heat exchange fluid 112, probably air, which passes through the condenser 111, that transfers heat out of the exhaust gases 24 (without mixing the heat exchange fluid 112 with the exhaust gases 24, in the typical function of a condenser). After exiting condenser 111, the combustion gases 24, now at a reduced temperature, move downstream through a gas-liquid conduit 113, to a pressure-control valve 114. The purpose of the pressure-control valve 114, is to maintain a back pressure that is desirable for the operation of the Recycled Combustion Engine, including the amount back pressure to help achieve the desired compression in the combustion chamber (variable compression) and achieve the desired pulling force enacted on the power-band 6. The pressure-control valve 114 also controls the desirable pressure and temperature conditions (by means of flow regulation) in the condenser 111 to cause liquification of the water component 24′ of the combustion gases 24, which in this case is the desire to separate the water condensate 24′ downstream of the condenser 111. Under normal operation of the Recycled Combustion Engine, it is expected that the state of the phase of the combustion gases 24 downstream of the condenser 111, barring any contaminants, would include both vapor phase combustion product 24, including carbon dioxide gas 24″, and water condensate 24′. Also, it is likely that efforts to condense the combustion gases 24 would further benefit from additional heat exchangers downstream of the pressure-control valve. For further pressure and temperature (by means of flow regulation) a pressure-control vent 115 can be installed downstream of the pressure-control valve 114 vent combustion gases 24 to the atmosphere after passing through the condenser 111, or after passing through the pressure-control valve 114.

As further shown in FIG. 10, the water condensate 24′ moves past the pressure-control valve 114 to a tee 116 that is installed in the gas-liquid conduit 113 to allow gravitational settling out of the water condensate 24′ into a water storage reservoir 117. The water condensate 24′ that is collected in the water storage reservoir 117 can be stored or transferred by a condensate pump 118 for reuse in the appropriate manner, including cooling at heat exchangers or condensers in the same process stream.

Referring again to FIG. 10, continuing past the tee 116 in the gas-liquid conduit 113, is the remaining component of the combustion gases 24, namely, carbon dioxide gas 24″. At this point, if it is desired, the carbon dioxide gas 24″ can be vented as a gas to either the atmosphere, or more desirably transferred to a carbon capture storage or reprocessing facility. To separate out the carbon dioxide gas 24″, into a carbon dioxide liquid 24″′, a high-pressure gas compressor 125 is used to compress the carbon dioxide gas 24″. Immediately downstream of the high-pressure gas compressor 125 is a high-pressure gas condenser 125′ that removes heat by means of heat transfer to a heat exchange fluid 112 in the form of a fluid cooling media, probably air. The high-pressure gas compressor 125′ and the high-pressure gas condenser 125′, produce a temperature and pressure condition where the carbon dioxide gas 24″ is condensed to a carbon dioxide liquid 24″′. The carbon dioxide liquid 24″′ is routed by means of a conduit 126 to a liquid carbon dioxide storage tank 127, where it can be transferred for reuse, recycling, or carbon capture.

As described for the combustion flow stream provided in FIG. 9 for the Recycled Combustion, it is understood that not all the combustion gas 24 resulting from the combustion of the fuel (hydrocarbon) and oxidizer (nearly pure oxygen gas in this example), must immediately be transferred through the condenser 111.

To give an example of the volumes associated with the disclosed embodiment for the combustion of a hydrocarbon and oxidizer (nearly pure oxygen), shown in FIG. 10, if an engine power requirement has a stochiometric hourly consumption of 200 moles of methane gas (CH₄ fuel gas volume of 4,480 liters, at standard temperature and pressure), and 400 moles of oxygen gas (oxidizer gas at 8,960 liters, at standard temperature and pressure), the resulting condensate of combustion would be 7.2 liters of liquid water 24′, and 8.7 liters of liquid CO₂ condensate 24′″, per hour. This corresponds to volume of 120 cc per minute of liquid water condensate 24′ from condenser 111, and 145 cc per minute of liquid CO₂ condensate 24″′ from the high-pressure gas condenser 125′.

Based on the phase diagram equilibria diagram for pure water, it is known that the temperature and pressure conditions of 99 degrees Celsius and 1 bar (absolute), respectively, will result in condensation of combustion gas water vapor 24 into liquid condensate 24′, and the temperature and pressure of 125 degrees Celsius and 2 bar, respectively, will result in condensation of the combustion gases 24 to a liquid water condensate 24′. Based on the phase equilibria diagram for carbon dioxide, a temperature and pressure condition of 25 degrees Celsius and 65 bar, respectively, will result in the condensation of carbon dioxide to carbon dioxide liquid 14″.

Referring to FIG. 10, it is for the sake of explaining the core components of the Recycled Combustion Engine that many necessary components are omitted, including valves, one-way check valves, flow regulators, filters, liquid-gas separators, flow a pressure controls and sensors, additional condensers and heat exchangers, and control fixtures. The necessary components are normal to those skilled in the design of gas and condensate flow streams.

Considering the embodiments disclosed with reference to FIGS. 9 and 10, and with reference to the phase diagrams for both water and carbon dioxide, it is expected that during the compression cycle (or compression stroke) described, for the Recycled Combustion Engine, depending on the temperature and pressure conditions, there could be condensation (gas to liquid phase transformation) occurring during the compression cycle. This condensation, including condensation of either water vapor (steam) or carbon dioxide, would involve energy inputs or outputs (depending on perspective) related to the latent heats of vaporization of either water or carbon dioxide. Also, during the power cycle (or power stroke), after fuel and oxidizer have been ignited, during combustion and expansion, the temperature and pressure conditions during the power cycle could cause vaporization of condensates of water and carbon dioxide. This vaporization, including vaporization of either water or carbon dioxide, would involve energy inputs or outputs (depending on perspective) related to the latent heats of vaporization of either water or carbon dioxide. Analysis of the energies associated with the compression and condensation of either the water vapor or carbon dioxide vapor during the compression cycle (or compression stroke) indicates there is an efficiency benefit to the compression cycle by reducing the volume of the gas being compressed. Analysis of the energies associated with the ignition of the fuel and oxidizer, with the recycled gases of either water vapor (steam) or carbon dioxide along with their condensates, during the expansion of the combustion gases during the power cycle (or power stroke) indicates there is an efficiency benefit to the power cycle by favorably slowing the rate, or lengthening the time, of combustion when using pure oxygen as the oxidizer (especially when using pure hydrogen for the fuel) and favorably increasing the volume of the gas being expanded.

Considering the embodiments disclosed with reference to FIGS. 9 and 10, it is appreciated that with nearly zero “air” intake into the combustion process, nitrogen is practically eliminated, reducing NOₓ (nitrous oxide) emission to near zero. It is common practice to inject fuel (fossil fuel or pure hydrogen) into an internal combustion engine, and it is common practice to recycle some exhaust gas (commonly referred to as Exhaust Gas Recycle—EGR) back into the cylinder during the intake stroke, but the injection of pure oxygen (that is, elimination of air as discussed above with reference to FIGS. 9 and 10) is unique, and is especially unique to the present valved-piston design of the present invention.

In accordance with the embodiments of the valved-piston assembly 4 described with reference to FIGS. 9 and 10, an internal combustion engine in which a stoichiometric ratio of pressurized fuel and oxidizer is injected into a sealed combustion chamber, without the inclusion of air, for ignition, combustion, subsequent expansion to do work, and exhaust. In accordance with an embodiment, the oxidizer is provided through an oxygen generator (or concentrator) and the oxygen generator is an ion exchange media using pressure swing adsorption (PSA) technology. In accordance with the embodiment disclosed with reference to FIG. 9, the fuel is nearly pure hydrogen, and the oxidizer is nearly pure oxygen, to produce a combustion gas of nearly pure water. The pressure on the exhaust side of the valved-piston assembly 4 associated with the internal combustion drive system 1000 is controlled with a pressure regulator mechanism to optimize condensation of the combustion gas. The combustion gases (water vapor) are routed to a condenser 111 and subsequently cooled to assist the causation of condensation of the combustion gases to liquid (water). The combustion gas condensate (water) is contained for reuse, including used as heat transfer media for heat exchangers or sent to electrolyzer for conversion to hydrogen and oxygen. The combustion gas condensate may also be converted to oxygen or carbon dioxide feedstock or carbon capture.

In accordance with another embodiment using nearly pure oxygen as disclosed with reference to FIG. 10, the fuel is hydrocarbon (natural gas, gasoline, diesel) and the oxidizer is nearly pure oxygen, to produce a combustion gas of nearly pure water and nearly pure oxides of carbon. The pressure on the exhaust side of the valved-piston assembly 4 associated with the internal combustion drive system 1000 is controlled with a pressure regulator mechanism to optimize condensation of the combustion gas, including condensation of water component of the combustion gases. It is also appreciated that the pressure on an exhaust side may be controlled with a pressure regulator mechanism to optimize condensation of the combustion gas within a heat exchanger, condenser, or compressor, including condensation to liquid phase of gaseous water component and gaseous carbon dioxide components of the combustion gases. The combustion gases (primarily water vapor and carbon dioxide) are routed to a condenser 111 (or heat exchanger) and subsequently cooled to cause condensation of the water vapor component of the combustion gases to liquid (water), and the remaining combustion gases continue to next processing step. The combustion gas condensate (water) is contained for reuse, including used as heat transfer media for heat exchangers or sent to electrolyzer for conversion to hydrogen and oxygen. The remaining combustion gases (primarily carbon dioxide) are routed to a compressor 125 for compression to a pressure to assist in the condensation of the combustion gases to liquid phase. The compressed remaining combustion gas (pressurized carbon dioxide) are routed to a condenser 125′ and cooled to cause condensation of the remaining component of the combustion gas (primarily carbon dioxide) to compressed liquid phase (carbon dioxide). The compressed liquid phase (carbon dioxide) of the remaining combustion gas is contained for carbon capture or reuse, including used as feedstock for reformation to carbon neutral fuel.

It is appreciated that if pure hydrogen is used as the fuel, and pure oxygen is used as the oxidizer, in the exhausted combustion gas 24, and if the exhausted combustion gas 24 can be condensed into pure liquid water, the power and thermal efficiency of the engine system would be increased by creating a low pressure suction (relative vacuum) on the opening port 13 of the valved-piston assembly 1. In such an embodiment, the opening port would not be atmospheric, but would rather be something closer to a vacuum. Condensers are commonly used in powerplants that run pressurized steam through a steam turbine. The vacuum created by the condensing steam creates a suction (vacuum) downstream of the turbine. This greatly increases the pressure differential across the turbine, greatly increasing the thermal efficiency. With this in mind, it is appreciated that a large engine, applying the principles of the valved-piston assembly 1 disclosed herein, could be used to retrofit existing fossil fired plants that have existing and functioning condensers. The use of this principle of condensing on the exhaust side of the valved-piston assembly 1 is not limited to large applications and could also be done on smaller displacement engines if heat exchange conditions could be met.

The descriptions provided above related to the increase in power output and efficiency of using condensers to create a low pressure (vacuum) downstream of the combustion and a subsequent pulling force enacted on the power-band 6, where this pulling force adds to the work output of the invention, can also be accomplished or supplemented with the use of a gas driven turbines. For example, a turbine (not shown in drawing) installed just prior to the condenser 111 shown in FIGS. 9 and 10, would serve to extract energy from the exhausted combustion gas 24. The energy extracted by the turbine (not shown in drawing), could be used for pumping or compressing of fluid (gas or liquid) or electrical generation. Various widely accepted turbine designs could be used in this application, including the Parsons turbine, Francis turbine, and Kaplan turbine. It is interesting to note that at the epitome of the reciprocating steam engine era, Parsons reaction low pressure turbines were used to extract energy from the steam just prior to the condenser, where the pressure was reduced to a “vacuum” of approximately 28-inch of mercury, including the Titanic and her sister ships Olympic and Britanic, where the center propeller (screw) was solely powered by the energy captured by the low pressure turbine. In a similar manner, the valved-piston assembly can be used to extract energy from the combustion gases.

There are well-founded beliefs that electricity from renewable energy sources can store energy by producing hydrogen with electrolyzers (electrolysis). It is a scientific fact that electrolyzers, while producing hydrogen gas, must produce an electrochemically equivalent reduction reaction, which could be a stoichiometric amount of oxygen gas (for every reduction reaction producing hydrogen from water, there must be an electrochemically equivalent oxidation reaction, which is most often the production of oxygen). It is another fact that the electrolyzers can produce high pressure gas (oxygen and hydrogen) without the use of compressors at incredibly high efficiency.

The ability of the present valved-piston assembly 1, herein described, to directly combust pressurized hydrogen or hydrocarbons, with pure oxygen, with a condensing cycle, and recycling of the combustion gases to achieve variable compression pressure (maximize compression pressure) results in a highly efficient system to store and produce electrical power, on a small or very large scale.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the description and claims appropriately interpreted by those skilled in the art.

1. An internal combustion drive system, comprising:
at least one crankshaft assembly; and
at least one valved-piston assembly that includes an exhaust-valve and a main piston-body positioned within a cylinder;
wherein the at least one crankshaft assembly is connected to the at least one valved-piston assembly via a flexible power-band to transmit power to the at least one crankshaft assembly.

2. The system according to claim 1, further including a stop mechanism at a top of the cylinder to make impact with the exhaust-valve assembly of the valved-piston assembly, causing the exhaust valve to momentarily open and release combustion gases.

3. An internal combustion drive system, comprising:
at least one first crankshaft assembly;
at least one second crankshaft assembly; and
at least one valved-piston assembly that includes an exhaust-valve assembly and a piston-body positioned within a cylinder,
wherein the at least one first crankshaft assembly is connected to the at least one valved-piston assembly via a flexible power-band to transmit power to the at least one first crankshaft assembly, and the at least one second crankshaft assembly being connected to the at least one valved-piston assembly via a flexible exhaust-band to actuate and move the exhaust-valve assembly relative to the main piston-body to open and close the at least one valved-piston assembly.

4. The system according to claim 3, wherein the cylinder includes a cylinder-plate assembly on one end of the cylinder and an atmospheric opening port on another end of the cylinder and the cylinder-plate assembly includes a fuel-intake-port, an oxidizer-intake-port, and a sparkplug.

5. The system according to claim 4, wherein pressurized fuel and pressurized oxidizer are injected into the fuel-intake-port and oxidizer-intake-port with mechanical, electrical, and/or electro-mechanical injectors.

6. The system according to claim 4, wherein the cylinder-plate assembly includes a stanchion with a hollow core to enable passage of at least one flexible power-band and at least one flexible exhaust-band connection to the at least one second crankshaft assembly.

7. The system according to claim 6, wherein the exhaust-valve assembly has the hollow core to closely match a diameter of the stanchion to enable the at least one valved-piston assembly to reciprocate on the stanchion.

8. The system according to claim 7, wherein the hollow core of the exhaust-valve assembly has a dynamic seal for engagement with an outer diameter of the stanchion.

9. The system according to claim 3, further including a first power-band idler assembly which guides the flexible power-band of the at least one first crankshaft assembly and provides a fixed and non-restrictive pivot point for motion of the flexible power-band of the at least one first crankshaft assembly, further including a second exhaust-band idler assembly which guides the flexible exhaust-band of the at least one second crankshaft assembly and provides a fixed and non-restrictive pivot point for motion of the flexible exhaust-band and the at least one second crankshaft assembly.

10. The system according to claim 3, wherein the second crankshaft assembly is in an advanced or retarded angle compared to the first crankshaft assembly.

11. The system according to claim 3, wherein the second crankshaft assembly is a different diameter compared to the first crankshaft assembly to affect open and close timing of the exhaust-valve assembly relative to the main piston-body.

12. The system according to claim 3, wherein shortening or lengthening of the flexible power-band or flexible exhaust-band affects timing of the opening and closing of the of the exhaust-valve assembly relative to the main piston-body.

13. The system according to claim 12, wherein a variable lift rotating cam is used to change the length of the flexible power-band or flexible exhaust-band, affecting timing of the opening and closing of the of the exhaust-valve assembly relative to the main piston-body, thereby changing an amount of compression during a compression cycle.

14. The system according to claim 3, wherein the main piston body includes a piston body bottom plate, a piston body exhaust valve seat, a piston body upper plate, a piston body flanged member, a piston body extension tube, and at least one dynamic seal.

15. The system according to claim 14, wherein the exhaust-valve assembly includes an exhaust valve plate, an exhaust valve seat, a flanged member, and at least one seal.

16. The system according to claim 15, wherein the exhaust-valve assembly also includes an inner extension tube and an outer extension tube that create an exhaust valve annulus that provides a path for pressurized lubrication and cooling.

17. The system according to claim 16, wherein the exhaust valve plate and the exhaust valve seat of the exhaust-valve assembly move relative to the piston body bottom plate and the piston body exhaust valve seat of the piston body to create a passageway for exhaust gas.

18. The system according to claim 3, wherein a bias force holds the exhaust-valve assembly and the main piston body in an open or closed position and the bias force is created by fluid pressure or a spring mechanism.

19. A method of using a valved-piston assembly, comprising a first crankshaft assembly functioning as a power-crankshaft assembly, a second crankshaft assembly functioning as an exhaust-crankshaft assembly, wherein the valved-piston assembly includes an exhaust-valve assembly and a main piston body positioned within a cylinder, wherein the valved-piston is connected to the first crankshaft assembly via a first flexible power-band to transmit power to an output shaft, and a second crankshaft assembly via a flexible exhaust-band to actuate the exhaust valve on and off, the method comprising:
(a) beginning with the first crankshaft assembly and the valved-piston assembly at 0-degrees rotation, with the exhaust-valve assembly of valved-piston closed, a combustion chamber charged with fuel and oxidizer;
(b) igniting fuel and oxidizer causing expanding combustion gas;
(c) expanding combustion gas exerts force on valved-piston rotating the first crankshaft assembly causing work to be done at a drive shaft, with additional force maintaining closure of exhaust-valve assembly of valved-piston due to closing force caused by combustion gas pressure on a frontal piston-body surface area portion of the valved-piston assembly, wherein continued expansion of combustion gases causing tension in the first flexible power-band connected to the first crankshaft assembly, wherein due to slack in the flexible exhaust-band during this period of rotation no force is transmitted between the valved-piston assembly and the second crankshaft;
(d) due to the shorter stroke length of the flexible exhaust-band connected to the second crankshaft, at a rotation angle just before 180-degrees further rotating the first crankshaft assembly causes the flexible exhaust-band to reach its top-dead-center of its shorter stroke length causing its upward motion to stop, causing full tension in the flexible exhaust-band, which causes the exhaust-valve assembly of the valved-piston assembly to open, releasing combustion gas out an end of the cylinder, where coinciding with transfer of tension from the first flexible power-band to the flexible exhaust-band of the second crankshaft assembly, causes downward motion of the exhaust-valve assembly of the valved-piston assembly with the valve open;
(e) further rotating the first crankshaft assembly causes the main piston-body to reach its top-dead-center at its 180-degree rotation, stop, and begin to accelerate down, and due to a longer stroke length of the first crankshaft assembly (compared to the second crankshaft assembly), the main piston-body accelerates downward at a higher rate of motion than the motion of the exhaust-valve assembly of the valved-piston assembly;
(f) at a predetermined position in a downward stroke, 250-degrees for example due to the higher acceleration of the main piston body, the main piston-body of the valved-piston assembly “catches up” with the exhaust-valve assembly of the valved-piston assembly, producing slack in the flexible exhaust-band which causes the exhaust-valve to seal against the main piston body, closing the valve and make a positive seal;
(g) a degree of rotation when the main piston-body of the valved-piston assembly “catches up” with the exhaust-valve assembly of the valved-piston assembly, coincides with transfer of tension from the flexible exhaust-band to the flexible power-band, and commences a compression stage of a cycle, where the combustion gases remaining in a combustion chamber area below the valved-piston assembly before the exhaust-valve closed are compressed by continuing rotation of the first crankshaft assembly and transfer of tension through the flexible power-band;
(h) injecting fuel and oxidizer some time between the 250-degrees and 360-degrees of rotation; and
(h) returning to the position of 0-degress for a next power stroke.

20. A combustion engine, comprising:
a valved piston assembly;
a hydrocarbon reservoir providing a source of hydrocarbon fuel; an oxygen reservoir and an oxygen generator providing a source of oxygen;
wherein hydrocarbon fuel is supplied to a fuel-intake-port of a combustion engine incorporating a valved-piston assembly and oxygen is supplied to an oxidizer-intake-port of a combustion engine incorporating a valved-piston assembly, thus allowing for injection of a stoichiometric ratio of pressurized fuel and oxidizer into a combustion chamber of the combustion engine.

21. The combustion engine according to claim 20, wherein the oxygen generator is an ion exchange media using pressure swing adsorption (PSA) technology.

22. An internal combustion drive system, comprising:
at least one first crankshaft assembly;
at least one second crankshaft assembly; and
at least one valved-piston assembly that includes an exhaust-valve assembly and a piston-body positioned within a cylinder;
wherein the at least one first crankshaft assembly is connected to the valved-piston assembly via a flexible power-band to transmit power to the at least one first crankshaft assembly, and the at least one second crankshaft assembly being connected to the at least one valved-piston assembly via a flexible exhaust-band to actuate to move the exhaust-valve assembly relative to the main piston-body to open and close the at least one valved-piston assembly, wherein changing a length of the flexible power-band changes an amount of compression done during a compression cycle, or compression portion of a 360-degree rotation, by adjusting how far down the valved-piston assembly will travel.

23. The system according to claim 22, wherein shortening the flexible power-band length, in real-time during operation, allows an infinitely variable compression ratio.
